(19) United States
(12) Patent Application Publication
(10) Pub. No.: US 2025/0158034 A1
(43) Pub. Date: May 15, 2025

(54) CATHODE ACTIVE MATERIAL FOR SOLID LITHIUM SECONDARY BATTERY, AND METHOD FOR MANUFACTURING CATHODE ACTIVE MATERIAL FOR SOLID LITHIUM SECONDARY BATTERY

(71) Applicant: SUMITOMO CHEMICAL COMPANY, LIMITED, Tokyo (JP)

(72) Inventors: Takuya KADOWAKI, Niihama-shi (JP); Ryo KURIKI, Niihama-shi (JP)

(21) Appl. No.: 18/835,129

(22) PCT Filed: Feb. 6, 2023
(86) PCT No.: PCT/JP2023/003713

§ 371 Date: Aug. 1, 2024

(30) Foreign Application Priority Data
Feb. 8, 2022 (JP) 2022-018061

(51) Int. Cl. H01M 4/36; H01M 4/02; H01M 4/04; H01M 4/505; H01M 4/525; H01M 10/052; H01M 10/0562

(52) U.S. Cl. CPC H01M 4/366; H01M 4/0409; H01M 4/0471; H01M 4/505; H01M 4/525; H01M 10/052; H01M 10/0562; H01M 2004/021; H01M 2004/028; H01M 2300/0068

(57) ABSTRACT

A cathode active material for solid lithium secondary battery is provided, containing a lithium metal composite oxide having a layered crystal structure, and a coating material which coats at least a part of the lithium metal composite oxide, in which the coating material contains an element A, the element A is one or more elements selected from the group consisting of Nb, Ta, Ti, Al, B, P, W, Zr, La, and Ge, and (1) and (2) are satisfied.

### TECHNICAL FIELD

The present invention relates to a cathode active material for solid lithium secondary battery, and a method for manufacturing a cathode active material for solid lithium secondary battery.

Priority is claimed on Japanese Patent Application No. 2022-018061, filed on Feb. 8, 2022, the content of which is incorporated herein by reference.

### BACKGROUND ART

A lithium secondary battery includes a liquid-type lithium secondary battery using an electrolytic solution containing an organic solvent, and a solid lithium secondary battery using a solid electrolyte. The solid lithium secondary battery was developed because it has an advantage in that the danger of liquid leakage, ignition, explosion, or the like is small and the battery can be used more safely than the liquid-type lithium secondary battery.

On the other hand, the solid lithium secondary battery has a disadvantage in that an interfacial resistance between an electrode active material and the solid electrolyte is likely to increase as compared with the liquid-type lithium secondary battery. In order to reduce the interfacial resistance between the electrode active material and the solid electrolyte and improve battery performance of the solid lithium secondary battery, an electrode active material including a coating layer has been studied.

For example, Patent Document 1 discloses a coating active material including a coating layer which contains a tungsten element. As a method for manufacturing such a coating active material, Patent Document 1 discloses a method of performing a hydrophilic treatment on a surface of an active material which is a core particle, before a coating step or simultaneously with the coating step. According to the disclosure of Patent Document 1, adhesion strength between the coating layer and the active material is improved by the hydrophilic treatment.

### CITATION LIST

### Patent Document

### [Patent Document 1]

PCT International Publication No. WO2012/105048

### SUMMARY OF INVENTION

### Technical Problem

In a case where the surface of the core particle is hydrophilized as disclosed in Patent Document 1, a coating active material having high coverage is easily obtained. However, a large amount of moisture is likely to remain in a cathode active material manufactured through excessive hydrophilic treatment. The moisture remaining in the cathode active material decomposes the electrolyte in contact with the cathode active material to form a resistance layer, and easily increases an interface at which lithium-ions cannot be satisfactorily conducted. In this case, a cathode active material which does not contribute to charging and discharging increases, and a utilization rate tends to decrease.

In the solid lithium secondary battery, it is desired that the cathode active material in the cathode active material layer sufficiently contribute to charging and discharging. For example, a cathode active material which is not in contact with the solid electrolyte cannot contribute to the charging and discharging, and thus becomes an unused active material. Specifically, the solid lithium secondary battery is required to have the same or similar utilization rate as the liquid-type lithium-ion secondary battery.

The present invention has been made in view of such circumstances, and an object of the present invention is to provide a cathode active material for solid lithium secondary battery, which has a high utilization rate, and to provide a method for manufacturing a cathode active material for solid lithium secondary battery.

In order to evaluate the utilization rate of the cathode active material in the solid lithium-ion battery, the utilization rate of the cathode active material is generalized regardless of composition of the cathode active material, and thus the “utilization rate of the cathode active material” is evaluated by a ratio of “charge and discharge capacity per unit mass of the active material in the battery” to “maximum capacity which can be charged and discharged per unit mass of the active material amount in the battery”. Specifically, the “utilization rate of the cathode active material” is a value obtained by dividing a second discharge capacity after the solid lithium secondary battery is charged and discharged once and a resistance layer which can be formed early is formed, by an initial charge capacity of a liquid-type lithium secondary battery using the same active material.

“Value of the utilization rate of the cathode active material is high” means that a proportion of a cathode material which can contribute to the charging and discharging is equal to or close to that of the liquid-type lithium-ion secondary battery.

### Solution to Problem

An aspect of the present invention includes [1] to [12].

[1] A cathode active material for solid lithium secondary battery, containing:
a lithium metal composite oxide having a layered crystal structure; and
a coating material which coats at least a part of the lithium metal composite oxide,
in which the coating material contains an element A,
the element A is one or more elements selected from the group consisting of Nb, Ta, Ti, Al, B, P, W, Zr, La, and Ge, and
the following (1) and (2) are satisfied,
(1) a surface presence rate of the coating material is 70% or more, and
(2) 0.10<(Va_{0.9}/S_{N})×(Vd_{0.5}−Va_{0.5})/Va_{0.9}<2.80,
[S_{N} is a BET specific surface area (unit: m²/g) of the cathode active material for solid lithium secondary battery, which is obtained by a measurement using a nitrogen adsorption method,
Va_{0.5} is a water vapor adsorption amount (unit: cm³ (STP)/g) of the cathode active material for solid lithium secondary battery in a case where, in an adsorption isotherm obtained by a measurement using a water vapor adsorption method, a relative pressure p/pₒ with a saturated vapor pressure p₀ is 0.5,
Va_{0.9} is a water vapor adsorption amount (unit: cm³ (STP)/g) in a case where, in the adsorption isotherm, the relative pressure p/pₒ is 0.9, and
Vd_{0.5} is a water vapor adsorption amount (unit: cm³ (STP)/g) in a case where, in a desorption isotherm obtained by a measurement using a water vapor adsorption method, the relative pressure p/pₒ is 0.5].

[2] The cathode active material for solid lithium secondary battery according to [1],
in which S_{H}, S_{N}, Va_{0.5}, Va_{0.9}, and Vd_{0.5} satisfy the following (3),

$$0.1 < ( {S}_{H} / {S}_{N} ) \times ( {Vd}_{0.5} - {Va}_{0.5} ) / {Va}_{0.9} < 3.1 , \qquad ( 3 )$$

[S_{H} is a BET specific surface area (unit: m²/g) of the cathode active material for solid lithium secondary battery, which is obtained by a measurement using a water vapor adsorption method].

[3] The cathode active material for solid lithium secondary battery according to or [2],
in which the cathode active material is used by being brought into contact with a solid electrolyte.

[4] The cathode active material for solid lithium secondary battery according to [3],
in which the solid electrolyte is a sulfide-based solid electrolyte.

[5] The cathode active material for solid lithium secondary battery according to any one of [1] to [4],
in which the element A is Nb, P, or B.

[6] The cathode active material for solid lithium secondary battery according to any one of [1] to [5],
in which the following formula (I) is satisfied,

(Li[Liₓ(Ni_{(1-y-z-w)}Co_{y}Mn_{z}M_{w})₁₋ₓ]O₂ (I)
(here, M is at least one element selected from the group consisting of Fe, Cu, Mg, Al, W, B, P, Mo, Zn, Sn, Zr, Ga, La, Ti, Nb, Ta, Ge, and V, and −0.10≤x≤0.30, 0≤y≤0.40, 0≤z≤0.40, and 0<w≤0.10 are satisfied).

[7] A method for manufacturing a cathode active material for solid lithium secondary battery, the method including:
a coating step of coating at least a part of a surface of a lithium metal composite oxide using a coating device,
wherein the coating device includes a treatment section in which the lithium metal composite oxide is flowable, and further includes a two-fluid nozzle which jets, toward the lithium metal composite oxide, a two-fluid jet containing a liquid coating raw material containing an element A and a carrier gas,
the element A is one or more elements selected from the group consisting of Nb, Ta, Ti, Al, B, P, W, Zr, La, and Ge,
the lithium metal composite oxide satisfies the following (A), and
Q_{g}, which is a flow rate (unit: g/min) of the carrier gas, and Qₗ, which is a flow rate (unit: g/min) of the coating raw material, satisfy the following (B),

$$0.1 < {Vl}_{0.9} / {L}_{N} < 6.8 , \qquad ( A )$$

(L_{N} is a BET specific surface area (unit: m²/g) of the lithium metal composite oxide, which is measured by a nitrogen adsorption method, and
Vl_{0.9} is a water vapor adsorption amount (unit: cm³ (STP)/g) of the lithium metal composite oxide in a case where, in an adsorption isotherm of a water vapor adsorption method, a relative pressure p/pₒ with a saturated vapor pressure p₀ is 0.9), and

$$0.6 < {Q}_{g} / {Q}_{l} \leq 25. . \qquad ( B )$$

[8] The method for manufacturing a cathode active material for solid lithium secondary battery according to [7], further including, after the coating step:
a heating step.

[9] The method for manufacturing a cathode active material for solid lithium secondary battery according to [8],
in which the heating step is a step of performing heating at a temperature of 100° C. or higher and 500° C. or lower for 1 hour or longer.

[10] The method for manufacturing a cathode active material for solid lithium secondary battery according to any one of [7] to [9],
in which the carrier gas is a gas having nitrogen as a main component.

[11] The method for manufacturing a cathode active material for solid lithium secondary battery according to any one of [7] to [10],
in which the cathode active material for solid lithium secondary battery satisfies the following formula (I),

(Li[Liₓ(Ni_{(1-y-z-w)}Co_{y}Mn_{z}M_{w})₁₋ₓ]O₂ (I)
(here, M is at least one element selected from the group consisting of Fe, Cu, Mg, Al, W, B, P, Mo, Zn, Sn, Zr, Ga, La, Ti, Nb, Ta, Ge, and V, and −0.10≤x≤0.30, 0≤y≤0.40, 0≤z≤0.40, and 0<w≤0.10 are satisfied)

[12] The method for manufacturing a cathode active material for solid lithium secondary battery according to any one of [7] to [11],
in which the coating step is a step of performing the coating using a roll-to-roll flow coating device.

### Advantageous Effects of Invention

According to the present invention, it is possible to provide a cathode active material for solid lithium secondary battery having a high utilization rate, and to provide a method for manufacturing a cathode active material for solid lithium secondary battery.

### BRIEF DESCRIPTION OF DRAWINGS

FIG. 1 is a schematic view showing a laminate included in a solid lithium-ion secondary battery.

FIG. 2 is a schematic view showing an example of a solid lithium secondary battery.

FIG. 3 is a schematic diagram showing an example of an adsorption isotherm and a desorption isotherm, obtained by a measurement of the cathode active material for solid lithium secondary battery at 25° C. using a water vapor adsorption method.

### DESCRIPTION OF EMBODIMENTS

### <Cathode Active Material for Solid Lithium Secondary Battery>

The present embodiment is a cathode active material for solid lithium secondary battery.

The cathode active material for solid lithium secondary battery contains core particles consisting of a lithium metal composite oxide having a layered crystal structure, and a coating material which coats at least a part of one particle of the core particles.

In the present specification, a metal composite compound will be referred to as “MCC”.

A lithium metal composite oxide will be referred to as “LiMO”.

A cathode active material for solid lithium secondary battery will be referred to as “CAM”.

The notation “Li” does not indicate a Li metal element, but a Li element, unless particularly otherwise specified. The same applies to notations of other elements such as Ni, Co, and Mn.

In a case where a numerical range is described as, for example, “1 to 10 μm”, the numerical range means a range from 1 μm to 10 μm, and means a numerical range including 1 μm as a lower limit value and 10 μm as an upper limit value.

### (LiMO)

The LiMO has a layered crystal structure and contains at least Li and a transition metal.

The LiMO contains, as the transition metal, at least one selected from the group consisting of Ni, Co, Mn, Fe, Cu, Mg, Al, W, B, Mo, Zn, Sn, Zr, Ga, La, Ti, Nb, and V.

In a case where the LiMO contains the above-described element as the transition metal, the obtained LiMO forms a stable crystal structure from which the Li ions can be easily removed or inserted.

### (Coating Material)

The coating material is a compound containing an element A.

The element A is one or more elements selected from the group consisting of Nb, Ta, Ti, Al, B, P, W, Zr, La, and Ge.

It is preferable that the coating material contain a lithium composite oxide containing the element A as a main component. The lithium composite oxide containing the element A is, for example, at least one oxide selected from the group consisting of LiNbO₃, LiTaO₃, Li₂TiO₃, LiAlO₂, Li₂WO₄, Li₄WO₅, Li₃BO₃, Li₂B₄O₇, Li₂ZrO₃, Li₃PO₄, Li₇La₃Zr₂O₁₂ (LLZ), Li_{1.5}Al_{0.5}Ge_{1.5}P₃O₁₂ (LAGP), Li_{1.3}Al_{0.3}Ti_{1.7}P₃O₁₂ (LATP), and Li₅La₃Ta₂O₁₂ (LLT). The above-described lithium composite oxide containing the element A preferably has lithium-ion conductivity.

The “using as the main component” the above-described oxide for the coating material means that the content of the above-described oxide is the highest among forming materials of the coating material. The content of the above-described oxide with respect to the entire coating material is preferably 50 mol % or more, and more preferably 60 mol % or more. In addition, the content of the above-described oxide with respect to the entire coating layer is preferably 90 mol % or less.

As a combination of a case in which the coating material contains two or more kinds of the above-described oxides, for example, a combination of LiNbO₃ and Li₃BO₃ and a combination of Li₃PO₄ and Li₃BO₃ are exemplary examples.

### [Overall Configuration of Solid Lithium-Ion Secondary Battery]

The CAM according to the present embodiment is used in contact with a solid electrolyte.

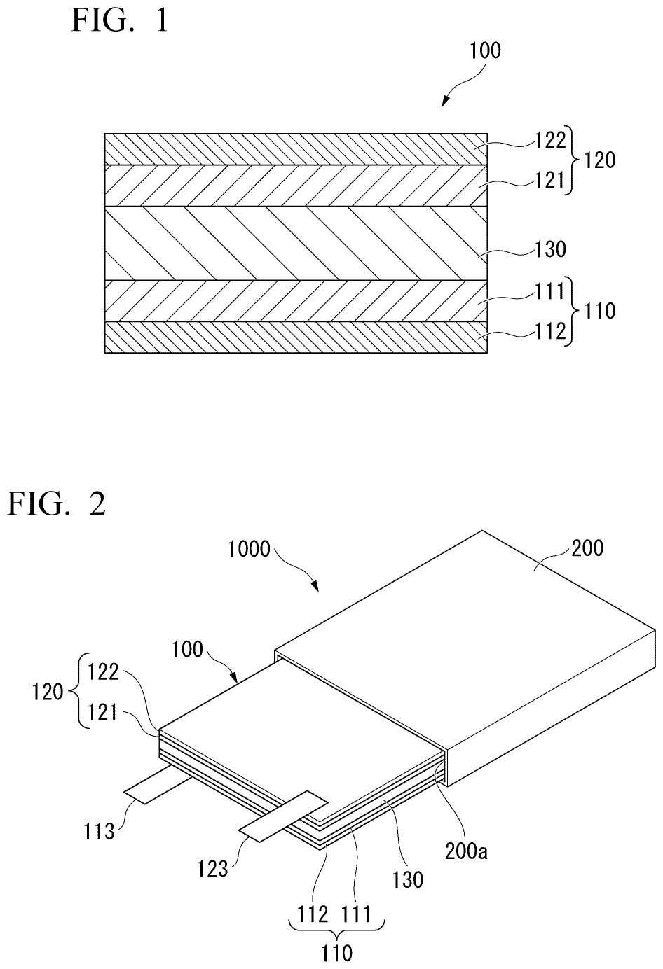

FIG. 1 is a schematic view showing a laminate included in the solid lithium-ion secondary battery.

A laminate 100 shown in FIG. 1 includes a cathode 110, an anode 120, and a solid electrolyte layer 130.

The cathode 110 has a cathode active material layer 111 and a cathode current collector 112.

The cathode active material layer 111 contains the CAM according to the present embodiment and a solid electrolyte. In the inside of the cathode active material layer 111, the CAM according to the aspect of the present invention is in contact with the solid electrolyte. In addition, the cathode active material layer 111 may contain a conductive material and a binder.

The anode 120 has an anode active material layer 121 and the anode current collector 122. In addition, the solid electrolyte layer 130 has a solid electrolyte.

FIG. 2 is a schematic view showing an overall configuration of the solid lithium-ion secondary battery. A solid lithium secondary battery 1000 shown in FIG. 2 has a laminate 100 having a cathode 110, an anode 120, and a solid electrolyte layer 130, and an exterior body 200 accommodating the laminate 100.

The laminate 100 may have an external terminal 113 which is connected to a cathode current collector 112 and an external terminal 123 which is connected to an anode current collector 122. In addition, the solid lithium secondary battery 1000 may have a separator between the cathode 110 and the anode 120.

A material which configures each member will be described below.

### <<Physical Properties of CAM>>

The CAM satisfies the following (1).

(1) a surface presence rate of the coating material present on a surface of the LiMO is 70% or more.

The surface presence rate of the coating material present on the surface of the LiMO can be confirmed by a measurement using X-ray photoelectron spectroscopy (XPS). The element A is present in the coating material contained in the CAM. Therefore, the surface presence ratio of the element A in all elements present on the surface of the CAM, which is obtained by measuring the surface of the CAM by the X-ray photoelectron spectroscopy, can be regarded as the surface presence rate of the coating material.

The surface presence rate of the element A is more preferably 75% or more, and still more preferably 80% or more.

The surface presence rate of the element A is, for example, 100% or less, 99% or less, or 98% or less.

The above-described upper limit value and lower limit value of the surface presence rate of the element A can be randomly combined together. The surface presence rate of the element A is, for example, 70% to 100%, 75% to 99%, or 80% to 98%.

In a case where the surface presence rate of the element A is equal to or more than the above-described lower limit value, it indicates that CAM in which the coating material containing the element A is sufficiently formed on the surface of the LiMO is obtained. Therefore, in the solid lithium secondary battery using the CAM, the LiMO is protected by the coating material, and the resistance layer is unlikely to be formed even in a case where any element is selected as the element A, and even in a case where charging and discharging are repeated in a state of being in contact with the electrolyte.

### [Method for Measuring Surface Presence Rate of Element A]

Since the element A is present in the coating material of the CAM, in a case where the XPS analysis is performed on the CAM, photoelectrons corresponding to the kinetic energy of the element A present in the coating material are detected.

The surface presence rate of the element A in the CAM is determined by using one particle of the CAM as a measurement target and analyzing the CAM by XPS.

Specifically, surface composition analysis of the CAM is performed under the following conditions to obtain a narrow scan spectrum on the surface of the CAM.
Measurement method: X-ray photoelectron spectroscopy (XPS)
X-ray radiation source: AlKα radiation (1486.6 eV)
X-ray spot diameter: 100 μm
Neutralization conditions: neutralization electron gun (acceleration voltage is adjusted depending on the element; current: 100 μA)

A detection depth of the XPS under the above-described conditions is in a range of approximately 3 nm from the surface of the CAM to the inside. In the CAM, in a portion where the coating material is thin or the coating material is not provided, the surface of the LiMO is analyzed in addition to the coating material.

The peak corresponding to each element can be identified using an existing database.

As a photoelectron intensity of Nb as the element A, an integrated value of a waveform of Nb3d is used.

As a photoelectron intensity of Ta as the element A, an integrated value of a waveform of Ta4f is used.

As a photoelectron intensity of Ti as the element A, an integrated value of a waveform of Ti2p is used.

As a photoelectron intensity of Al as the element A, an integrated value of a waveform of Al2p is used.

As a photoelectron intensity of B as the element A, an integrated value of a waveform of B1s is used.

As a photoelectron intensity of P as the element A, an integrated value of a waveform of P2p is used.

As a photoelectron intensity of W as the element A, an integrated value of a waveform of W4f is used. However, in a case of being measured at the same time as Ge, an integrated value of a background of W4d is used.

As a photoelectron intensity of Zr as the element A, an integrated value of a waveform of Zr3d is used.

As a photoelectron intensity of La as the element A, an integrated value of a waveform of La3d5/2 is used.

As a photoelectron intensity of Ge as the element A, an integrated value of a waveform of Ge2p is used.

In addition, in the same XPS analysis, photoelectrons corresponding to the kinetic energy of each element are also detected for the transition metal contained in the LiMO.

As the transition metal contained in the LiMO, for example, an integrated value of a waveform of Ni2p3/2 is used as a photoelectron intensity of Ni.

As the transition metal contained in the LiMO, an integrated value of a waveform of Co2p3/2 is used as a photoelectron intensity of Co.

As the transition metal contained in the LiMO, an integrated value of a waveform of Mn2p1/2 is used as a photoelectron intensity of Mn.

The ratio of values obtained by performing sensitivity correction for each element from the photoelectron intensity of each element in the obtained spectrum corresponds to the element ratio of the CAM obtained by the XPS measurement.

In the CAM to be measured, there is a case in which an element common to the coating material and the LiMO is contained. In this case, the above-described element ratio in the XPS analysis result is handled without distinguishing whether the element is an element contained in the coating material or an element contained in the LiMO.

For example, in a case where Ti is contained in both the coating material and the LiMO, the element ratio of Ti obtained as the XPS analysis result is handled as the total element ratio of Ti contained in the LiMO and Ti contained in the coating material.

The CAM satisfies the following (2).

$$0.1 < ( {Va}_{0.9} / {S}_{N} ) \times ( {Vd}_{0.5} - {Va}_{0.5} ) / {Va}_{0.9} < 2.8 \qquad ( 2 )$$

[S_{N} is a BET specific surface area (unit: m²/g) of the CAM which is obtained by a measurement using a nitrogen adsorption method,
Va_{0.5} is a water vapor adsorption amount (unit: cm³ (STP)/g) of the CAM in a case where, in an adsorption isotherm obtained by a measurement using a water vapor adsorption method, a relative pressure p/pₒ with a saturated vapor pressure p₀ is 0.5,
Va_{0.9} is a water vapor adsorption amount (unit: cm³ (STP)/g) of the CAM in a case where the relative pressure p/pₒ is 0.9, and
Vd_{0.5} is a water vapor adsorption amount (unit: cm³ (STP)/g) of the CAM in a case where, in a desorption isotherm obtained by a measurement using a water vapor adsorption method, the relative pressure p/pₒ is 0.5]
   [Va_{0.9}/S_{N}]

In a case where the Va_{0.9} is regarded as a water vapor amount which can be adsorbed by the CAM, a value obtained by dividing the Va_{0.9} by the S_{N}, which is the specific surface area of the CAM, is the water vapor amount which can be retained by the CAM per unit specific surface area. A large value of Va_{0.9}/S_{N} means that a large amount of water vapor can be retained, that is, hydrophilicity is high. Hereinafter, the Va_{0.9}/S_{N} is referred to as “hydrophilic index”.

$$Hydrophilic index = ( {Va}_{0.9} / {S}_{N} )$$

[(Vd_{0.5}−Va_{0.5})/Va_{0.9}]

For the CAM, an adsorption isotherm and a desorption isotherm obtained by a measurement using a water vapor adsorption method at 25° C. are acquired, and the value of “(Vd_{0.5}−Va_{0.5})/Va_{0.9}” is obtained. Hereinafter, the “(Vd_{0.5}−Va_{0.5})/Va_{0.9}” is referred to as “water retention index”. As the water retention index becomes higher, the moisture is easily retained, and as the water retention index becomes lower, the moisture is easily released.

$$Water retention index = ( {Vd}_{0.5} - {Va}_{0.5} ) / {Va}_{0.9}$$

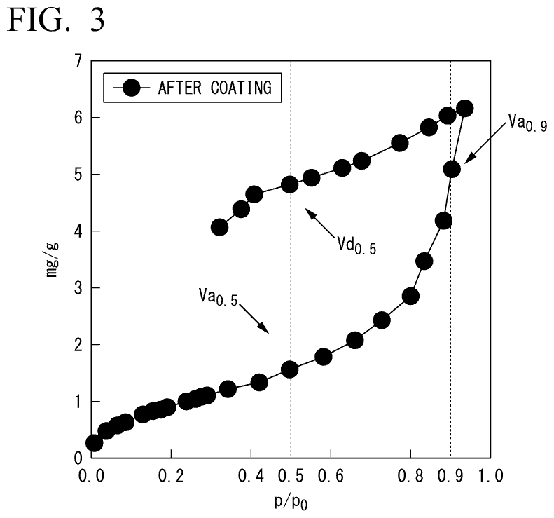

FIG. 3 shows an example of an adsorption isotherm and a desorption isotherm, obtained by a measurement of the CAM at 25° C. using a water vapor adsorption method.

Va_{0.5} is a water vapor adsorption amount (unit: cm³ (STP)/g) per 1 g of the CAM in a case where, in the adsorption isotherm, a relative pressure p/pₒ is 0.5.

Va_{0.9} is a water vapor adsorption amount (unit: cm³ (STP)/g) per 1 g of the CAM in a case where, in the adsorption isotherm, a relative pressure p/pₒ is 0.9.

Vd_{0.5} is a water vapor adsorption amount (unit: cm³ (STP)/g) per 1 g of the CAM in a case where, in the desorption isotherm, a relative pressure p/pₒ is 0.5.

### [Acquisition Method of Adsorption Isotherm and Desorption Isotherm Obtained by Measurement Using Water Vapor Adsorption Method]

p represents a water vapor pressure at 25° C., and pₒ represents a saturated water vapor pressure at 25° C. The adsorption isotherm and the desorption isotherm obtained by the measurement using the water vapor adsorption method can be acquired using a vapor adsorption measuring device. As the adsorption measuring device, for example, “BELSORP-18” manufactured by MicrotracBEL Corp. can be used.

Measurement conditions in a case of using the “BELSORP-18” manufactured by MicrotracBEL Corp. are as follows.
Filling sample amount: 0.5 g
Pre-processing conditions of sample: treatment at 200° C. for 5 hours under vacuum
Constant temperature bath temperature: 50° C.
Adsorption temperature: 25° C.
Saturated vapor pressure: 3.169 kPa
Adsorption equilibrium time: 500 seconds

As shown in FIG. 3, as the relative pressure p/pₒ in the adsorption isotherm increases, the water vapor is adsorbed on the CAM, and the water vapor adsorption amount increases. The relative pressure is increased until the relative pressure p/pₒ exceeds 0.9 to advance adsorption of the water vapor on the CAM, and the relative pressure is decreased to advance desorption of the water vapor from the CAM. In the desorption isotherm, as the relative pressure p/pₒ decreases, the water vapor is desorbed from the CAM, and the water vapor adsorption amount decreases.

As shown in FIG. 3, in a case where the relative pressure p/pₒ is 0.5, the water vapor adsorption amount Vd_{0.5} in the desorption isotherm is larger than the water vapor adsorption amount Va_{0.5} in the adsorption isotherm. That is, (Vd_{0.5}−Va_{0.5}) is larger than 0, and hysteresis occurs between the adsorption process and the desorption process.

In consideration of the influence of the hysteresis on the relative pressure p/pₒ, in the present embodiment, (Vd_{0.5}−Va_{0.5}), which is a water retention index based on the Va_{0.9}, which is the maximum value of the water vapor adsorption amount, is used as a reference of the hysteresis.

### [Method for Measuring BET Specific Surface Area]

The “BET specific surface area” is a value which is measured by the Brunauer, Emmet, and Teller (BET) method. In the measurement of S_{N}, a nitrogen gas is used as an adsorbed gas. For example, after drying 8 g of the CAM powder at 120° C. for 5 hours in a vacuum environment, the BET specific surface area (unit: m²/g) can be measured using a nitrogen adsorption specific surface area and pore size distribution measuring device (for example, BELSORP-mini manufactured by MicrotracBEL Corp.). In this case, the analysis cell containing the CAM powder is immersed in liquid nitrogen, and the amount of nitrogen gas adsorbed is measured.

The value of (Va_{0.9}/S_{N})×(Vd_{0.5}−Va_{0.5})/Va_{0.9} is a product of the water retention index and the hydrophilic index of the CAM, and is an index indicating the amount of moisture remaining in the CAM.

The moisture remaining in the CAM is mainly from the manufacturing process. In a case where the value of (Va_{0.9}/S_{N})×(Vd_{0.5}−Va_{0.5})/Va_{0.9} is large, it is considered that an excessive amount of moisture is retained in the CAM. In the manufacturing process of the solid battery, moisture excessively remaining in the CAM reacts with the solid electrolyte to cause formation of the resistance layer.

In addition, in a case where the value of (Va_{0.9}/S_{N})×(Vd_{0.5}−Va_{0.5})/Va_{0.9} is small, it means that a load in a drying step in a process from the cathode material production to the solid battery production is low, and in a case where the cathode material is dried to a residual moisture content which is less likely to affect the solid battery, the drying can be performed at a lower temperature and for a shorter time.

In the manufacturing process of the CAM, it is desirable to adjust the surface of the LiMO to be hydrophilic in order to form the coating material in an optimum manner, but in a case where a large amount of moisture remains in the manufactured CAM, the moisture is a cause of forming the resistance layer for the above-described reason, which is not preferable.

In a case where the value of (Va_{0.9}/S_{N})×(Vd_{0.5}−Va_{0.5})/Va_{0.9} is less than the above-described upper limit value, the moisture remaining in the CAM is reduced, and thus the resistance layer is unlikely to be formed in a range of being in contact with the solid electrolyte.

In a case where the value of (Va_{0.9}/S_{N})×(Vd_{0.5}−Va_{0.5})/Va_{0.9} is 0.10 or less, the CAM is hydrophobic. Each component (dispersion force, orientation force, and hydrogen bonding force) of the surface free energy of the hydrophobic CAM is significantly different from each component of the surface free energy of the solid electrolyte. Therefore, it is considered difficult for the hydrophobic CAM to be compatible with the solid electrolyte, and difficult to form an interface between the CAM and the solid electrolyte in contact with the CAM. Therefore, it is preferable that the value of (Va_{0.9}/S_{N})×(Vd_{0.5}−Va_{0.5})/Va_{0.9} be more than 0.10.

The (2) is preferably any one of the following (2)-1 to (2)-3.

$$1 : 0.2 < ( {Va}_{0.9} / {S}_{N} ) \times ( {Vd}_{0.5} - {Va}_{0.5} ) / {Va}_{0.9} < 2.75 \qquad ( 2 )$$

$$2 : 0.3 < ( {Va}_{0.9} / {S}_{N} ) \times ( {Vd}_{0.5} - {Va}_{0.5} ) / {Va}_{0.9} < 2.7 \qquad ( 2 )$$

$$3 : 0.5 < ( {Va}_{0.9} / {S}_{N} ) \times ( {Vd}_{0.5} - {Va}_{0.5} ) / {Va}_{0.9} < 2.65 \qquad ( 2 )$$

The CAM preferably satisfies the following (3).

$$0.1 < ( {S}_{H} / {S}_{N} ) \times ( {Vd}_{0.5} - {Va}_{0.5} ) / {Va}_{0.9} < 3.1 \qquad ( 3 )$$

[S_{H} is a BET specific surface area (unit: m²/g) of the CAM which is obtained by a measurement using a water vapor adsorption method]

From the ratio of S_{H}, which is the BET specific surface area calculated using water molecules as the adsorptive species, to S_{N}, which is the BET specific surface area calculated using nitrogen as the adsorptive species, a comparison of the hydrophilicity of the surface of the CAM can be obtained. The S_{N} is a specific surface area of the CAM surface, and the S_{H} is a specific surface area of the CAM surface on which a hydrophilic group is present.

As the value of S_{H}/S_{N} becomes larger, the hydrophilic group is more present on the surface of the CAM.

The same as (2), the value of (S_{H}/S_{N})×(Vd_{0.5}−Va_{0.5})/Va_{0.9} is a product of an index indicating the water retention index of the CAM and an index indicating the hydrophilicity, and is an index indicating the amount of moisture which can be retained by the CAM from the manufacturing to the battery formation.

In a case where the value of (S_{H}/S_{N})×(Vd_{0.5}−Va_{0.5})/Va_{0.9} is less than the above-described upper limit value, the moisture remaining in the CAM is reduced, and thus the resistance layer is unlikely to be formed in a range of being in contact with the solid electrolyte.

In addition, for example, a hydroxyl group reacts easily with lithium, and reacts with residual lithium which has not been incorporated into crystals, which causes the formation of the resistance layer. Furthermore, the hydroxyl group easily adsorbs moisture in the air, and residual moisture in the manufacturing process of the solid battery reacts with the solid electrolyte, which causes the solid electrolyte to be decomposed and the resistance layer to be formed. In a case where the value of (S_{H}/S_{N})×(Vd_{0.5}−Va_{0.5})/Va_{0.9} is less than the above-described upper limit value, the number of hydrophilic groups is small in a range in which the moisture is easily released, and thus the reaction of forming such a resistance layer is less likely to occur.

In a case where the value of (S_{H}/S_{N})×(Vd_{0.5}−Va_{0.5})/Va_{0.9} is 0.10 or less, the CAM is hydrophobic. Each component (dispersion force, orientation force, and hydrogen bonding force) of the surface free energy of the hydrophobic CAM is significantly different from each component of the surface free energy of the solid electrolyte. Therefore, it is considered difficult for the hydrophobic CAM to be compatible with the solid electrolyte, and difficult to form an interface between the CAM and the solid electrolyte in contact with the CAM. Therefore, it is preferable that the value of (S_{H}/S_{N})×(Vd_{0.5}−Va_{0.5})/Va_{0.9} be more than 0.10.

The (3) is preferably any one of the following (3)-1 to (3)-3.

$$1 : 0.2 < ( {S}_{H} / {S}_{N} ) \times ( {Vd}_{0.5} - {Va}_{0.5} ) / {Va}_{0.9} < 3. \qquad ( 3 )$$

$$2 : 0.3 < ( {S}_{H} / {S}_{N} ) \times ( {Vd}_{0.5} - {Va}_{0.5} ) / {Va}_{0.9} < 2.9 \qquad ( 3 )$$

$$3 : 0.5 < ( {S}_{H} / {S}_{N} ) \times ( {Vd}_{0.5} - {Va}_{0.5} ) / {Va}_{0.9} < 2.65 \qquad ( 3 )$$

### (Compositional Formula)

The CAM preferably satisfies the following formula (I).

(Li[Liₓ(Ni_{(1-y-z-w)}Co_{y}Mn_{z}M_{w})₁₋ₓ]O₂ (I)
(here, M is at least one element selected from the group consisting of Fe, Cu, Mg, Al, W, B, P, Mo, Zn, Sn, Zr, Ga, La, Ti, Nb, Ta, Ge, and V, and −0.10≤x≤0.30, 0≤y≤0.40, 0≤z≤0.40, and 0<w≤0.10 are satisfied)

### (Regarding x)

From the viewpoint of obtaining a lithium-ion secondary battery having favorable cycle characteristics, x in the compositional formula (I) is preferably more than 0, more preferably 0.01 or more, and still more preferably 0.02 or more. In addition, from the viewpoint of obtaining a lithium secondary battery having a higher initial charge and discharge efficiency, x in the compositional formula (I) is preferably 0.25 or less, and more preferably 0.10 or less.

In the present specification, “favorable cycle characteristics” means a characteristic in which a decrease in battery capacity due to repeated charging and discharging is small, and means that a capacity ratio in re-measurement with respect to the initial capacity is unlikely to decrease.

In addition, in the present specification, the “initial charge and discharge efficiency” is a value obtained by “(Initial discharge capacity)/(Initial charge capacity)×100(%)”. The secondary battery having a high initial charge and discharge efficiency has a small irreversible capacity during the first charging and discharging, and is likely to have a larger capacity per volume and weight.

The upper limit value and lower limit value of x can be randomly combined together. In the compositional formula (I), x may be −0.10 to 0.25, or −0.10 to 0.10.

x may be more than 0 and 0.30 or less, more than 0 and 0.25 or less, or more than 0 and 0.10 or less.

x may be 0.01 to 0.30, 0.01 to 0.25, or 0.01 to 0.10.

x may be 0.02 to 0.3, 0.02 to 0.25, or 0.02 to 0.10.

It is preferable that x satisfy 0<x≤0.30.

### (Regarding y)

In addition, from the viewpoint of obtaining a lithium-ion secondary battery having low internal resistance, y in the compositional formula (I) is preferably more than 0, more preferably 0.005 or more, still more preferably 0.01 or more, and particularly preferably 0.05 or more. In addition, from the viewpoint of obtaining a lithium secondary battery having high thermal stability, y in the compositional formula (I) is more preferably 0.35 or less, still more preferably 0.33 or less, and even more preferably 0.30 or less.

The upper limit value and lower limit value of y can be randomly combined together. In the compositional formula (I), y may be 0 to 0.35, 0 to 0.33, or 0 to 0.30.

y may be more than 0 and 0.40 or less, more than 0 and 0.35 or less, more than 0 and 0.33 or less, or more than 0 and 0.30 or less.

y may be 0.005 to 0.40, 0.005 to 0.35, 0.005 to 0.33, or 0.005 to 0.30.

y may be 0.01 to 0.40, 0.01 to 0.35, 0.01 to 0.33, or 0.01 to 0.30.

y may be 0.05 to 0.40, 0.05 to 0.35, 0.05 to 0.33, or 0.05 to 0.30.

It is preferable that y satisfy 0<y≤0.40.

In the compositional formula (I), it is more preferable that 0<x≤0.10 and 0<y≤0.40.

### (Regarding z)

In addition, from the viewpoint of obtaining a lithium secondary battery having favorable cycle characteristics, z in the compositional formula (I) is preferably more than 0, more preferably 0.01 or more, still more preferably 0.02 or more, and particularly preferably 0.1 or more. In addition, from the viewpoint of obtaining a lithium secondary battery having high storage stability at a high temperature (for example, under an environment of 60° C.), z in the compositional formula (I) is preferably 0.39 or less, more preferably 0.38 or less, and still more preferably 0.35 or less.

The upper limit value and lower limit value of z can be randomly combined together. In the compositional formula (I), z may be 0 to 0.39, 0 to 0.38, or 0 to 0.35.

z may be 0.01 to 0.40, 0.01 to 0.39, 0.01 to 0.38, or 0.01 to 0.35.

z may be 0.02 to 0.40, 0.02 to 0.39, 0.02 to 0.38, or 0.02 to 0.35.

z may be 0.10 to 0.40, 0.10 to 0.39, 0.10 to 0.38, or 0.10 to 0.35.

### (Regarding w)

In addition, from the viewpoint of obtaining a lithium secondary battery having low internal resistance, w in the compositional formula (I) is preferably more than 0, more preferably 0.0005 or more, and still more preferably 0.001 or more. In addition, from the viewpoint of obtaining a lithium secondary battery having a large discharge capacity at a high current rate, w in the compositional formula (I) is preferably 0.09 or less, more preferably 0.08 or less, and still more preferably 0.07 or less.

The upper limit value and lower limit value of w can be randomly combined 20 together. In the compositional formula (I), w may be more than 0 and 0.10 or less, more than 0 and 0.09 or less, more than 0 and 0.08 or less, or more than 0 and 0.07 or less.

w may be 0.0005 to 0.10, 0.0005 to 0.09, 0.0005 to 0.08, or 0.0005 to 0.07.

w may be 0.001 to 0.10, 0.001 to 0.09, 0.001 to 0.08, or 0.001 to 0.07.

(Regarding y+z+w)

In addition, from the viewpoint of obtaining a lithium secondary battery having a large battery capacity, y+z+w in the compositional formula (1) is preferably 0.50 or less, more preferably 0.48 or less, and still more preferably 0.46 or less.

With regard to the CAM, it is preferable that, in the compositional formula (I), 0.50≤1−y−z−w≤0.95 and 0≤y≤0.30. That is, it is preferable that the CAM have a Ni content molar ratio of 0.50 or more and a Co content molar ratio of 0.30 or less in the compositional formula (I).

In addition, from the viewpoint of obtaining a lithium secondary battery having high cycle characteristics, it is preferable that M in the compositional formula (I) be Nb, P, or B.

An example of a preferred combination of x, y, z, and w described above is that x is 0.02 to 0.3, y is 0.05 to 0.30, z is 0.02 to 0.35, and w is more than 0 and 0.07 or less.

As the CAM having a preferred combination of x, y, z, and w, for example, the CAM in which x=0.05, y=0.20, z=0.30, and w=0.0005; the CAM in which x=0.05, y=0.08, z=0.04, and w=0.0005; and the CAM in which x=0.25, y=0.07, z=0.02, and w=0.0005 are exemplary examples.

In a case where the element A constituting the coating material and the transition metal element constituting the LiMO overlap, the overlapping element is treated as the element constituting the coating material.

### [Composition Analysis]

A composition of the CAM can be analyzed using an inductively coupled plasma emission (ICP) spectrometer (for example, SPS3000 manufactured by Seiko Instruments Inc.) after the CAM is dissolved in hydrochloric acid.

### (Crystal Structure)

A crystal structure of the LiMO is layered. The crystal structure of the LiMO is more preferably a hexagonal crystal structure or a monoclinic crystal structure.

The hexagonal crystal structure belongs to any one space group selected from the group consisting of P3, P3₁, P3₂, R3, P-3, R-3, P312, P321, P3₁12, P3₁21, P3₂12, P3₂21, R32, P3 m1, P31m, P3c1, P31c, R3m, R3c, P-31m, P-31c, P-3 ml, P-3cd, R-3m, R-3c, P6, P6₁, P6₅, P6₂, P6₄, P6₃, P-6, P6/m, P6₃/m, P622, P6₁22, P6₅22, P6₂22, P6₄22, P6₃22, P6mm, P6cc, P6₃cm, P6₃mc, P-6m2, P-6c2, P-62m, P-62c, P6/mmm, P6/mcc, P6₃/mcm, and P6₃/mmc.

In addition, the monoclinic crystal structure belongs to any one space group selected from the group consisting of P2, P2₁, C2, Pm, Pc, Cm, Cc, P2/m, P2₁/m, C2/m, P2/c, P2₁/c, and C2/c.

Among these, in order to obtain a lithium secondary battery having a high discharge capacity, the crystal structure is particularly preferably a hexagonal crystal structure belonging to the space group R-3m or a monoclinic crystal structure belonging to the space group C2/m.

It is preferable that the CAM contain secondary particles which are an aggregate of primary particles.

In the present specification, “primary particles” means particles that have no grain boundary in appearance and constitute the secondary particles. In more detail, “primary particles” means particles in which no clear grain boundary is visible from the particle surface in the case of being observed in a visual field magnified 5,000 to 20,000 times with a scanning electron microscope or the like.

In the present specification, “secondary particles” means particles in which a plurality of the primary particles are three-dimensionally bonded to each other with a gap. The secondary particles have a spherical shape or a substantially spherical shape.

In general, the secondary particles are formed by aggregation of 10 or more of the primary particles.

### <<Solid Electrolyte>>

As the solid electrolyte in contact with the CAM according to the present embodiment, a solid electrolyte which has lithium-ion conductivity and is used in known solid lithium secondary battery can be adopted. As the solid electrolyte, an inorganic electrolyte and an organic electrolyte can be exemplary examples. As the inorganic electrolyte, an oxide-based solid electrolyte, a sulfide-based solid electrolyte, and a hydride-based solid electrolyte can be exemplary examples. As the organic electrolyte, polymer-based solid electrolytes are exemplary examples. As each electrolyte, compounds described in WO2020/208872A1, US2016/0233510A1, US2012/0251871A1, and US2018/0159169A1 are exemplary examples, and the following compounds are exemplary examples.

### (Oxide-Based Solid Electrolyte)

As the oxide-based solid electrolyte, for example, a perovskite-type oxide, a NASICON-type oxide, a LISICON-type oxide, a garnet-type oxide, and the like are exemplary examples. As specific examples of each oxide, compounds described in WO2020/208872A1, US2016/0233510A1, and US2020/0259213A1 are exemplary examples, and for example, the following compounds are exemplary examples.

As the perovskite-type oxide, Li—La—Ti-based oxides such as LiₐLa₁₋ₐTiO₃ (0<a<1), Li—La—Ta-based oxides such as Li_{b}La_{1-b}TaO₃ (0<b<1), Li—La—Nb-based oxides such as Li_{c}La_{1-c}NbO₃ (0<c<1), and the like are exemplary examples.

As the NASICON-type oxide, Li_{1+d}Al_{d}Ti_{2-d}(PO₄)₃ (0≤d≤1) and the like are exemplary examples. The NASICON-type oxide is an oxide represented by LiₘM¹ₙM²ₒPₚO_{q} (in the formula, M¹ is one or more elements selected from the group consisting of B, Al, Ga, In, C, Si, Ge, Sn, Sb, and Se; M² is one or more elements selected from the group consisting of Ti, Zr, Ge, In, Ga, Sn, and Al; and m, n, o, p, and q are random positive numbers).

As the LISICON-type oxide, oxides represented by Li₄M³O₄-Li₃M⁴O₄ (M³ is one or more elements selected from the group consisting of Si, Ge, and Ti; and M⁴ is one or more elements selected from the group consisting of P, As, and V) and the like are exemplary examples.

As the garnet-type oxide, Li—La—Zr-based oxides such as Li₇La₃Zr₂O₁₂ (also referred to as LLZ) are exemplary examples.

The oxide-based solid electrolyte may be a crystalline material or an amorphous material.

### (Sulfide-Based Solid Electrolyte)

As the sulfide-based solid electrolyte, Li₂S—P₂S₅-based compounds, Li₂S—SiS₂-based compounds, Li₂S—GeS₂-based compounds, Li₂S—B₂S₃-based compounds, LiI—Si₂S—P₂S₅-based compounds, LiI—Li₂S—P₂O₅-based compounds, LiI—Li₃PO₄-P₂S₅-based compounds, Li₁₀GeP₂S₁₂-based compounds, and the like can be exemplary examples.

In the present specification, the expression “-based compound” that indicates the sulfide-based solid electrolyte is used as a general term for solid electrolytes mainly containing a raw material written before “-based compound” such as “Li₂S” or “P₂S₅”. For example, the Li₂S—P₂S₅-based compounds include solid electrolytes mainly containing Li₂S and P₂S₅ and further containing a different raw material. A proportion of Li₂S which is contained in the Li₂S—P₂S₅-based compound is, for example, 50% to 90% by mass with respect to the entire Li₂S—P₂S₅-based compound. A proportion of P₂S₅ which is contained in the Li₂S—P₂S₅-based compound is, for example, 10% to 50% by mass with respect to the entire Li₂S—P₂S₅-based compound. In addition, a proportion of the different raw material which is contained in the Li₂S—P₂S₅-based compound is, for example, 0% to 30% by mass with respect to the entire Li₂S—P₂S₅-based compound. In addition, the Li₂S—P₂S₅-based compounds also include solid electrolytes containing Li₂S and P₂S₅ in different mixing ratios.

As the Li₂S—P₂S₅-based compounds, Li₂S—P₂S₅, Li₂S—P₂S₅—LiI, Li₂S—P₂S₅—LiCl, Li₂S—P₂S₅—LiBr, Li₂S—P₂S₅—LiI—LiBr, Li₂S—P₂S₅—Li₂O, Li₂S—P₂S₅—Li₂O—LiI, Li₂S—P₂S₅—ZₘSₙ (m and n are positive numbers; and Z is Ge, Zn, or Ga), and the like are exemplary examples.

As the Li₂S—SiS₂-based compounds, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—SiS₂—P₂S₅—LiCl, Li₂S—SiS₂—Li₃PO₄, Li₂S—SiS₂—Li₂SO₄, Li₂S—SiS₂-LiₓMO_{y} (x and y are positive numbers; and M is P, Si, Ge, B, Al, Ga, or In), and the like are exemplary examples.

As the Li₂S—GeS₂-based compounds, Li₂S—GeS₂, Li₂S—GeS₂—P₂S₅, and the like are exemplary examples.

The sulfide-based solid electrolyte may be a crystalline material or an amorphous material.

### (Hydride-Based Solid Electrolyte)

As the hydride-based solid electrolyte material, LiBH₄, LiBH₄-3KI, LiBH₄—PI₂, LiBH₄—P₂S₅, LiBH₄—LiNH₂, 3LiBH₄—LiI, LiNH₂, Li₂AlH₆, Li(NH₂)₂I, Li₂NH, LiGd(BH₄)₃Cl, Li₂(BH₄)(NH₂), Li₃(NH₂)I, Li₄(BH₄)(NH₂)₃, and the like can be exemplary examples.

### (Polymer-Based Solid Electrolyte)

As the polymer-based solid electrolyte, for example, organic polymer electrolytes such as polymer compounds containing one or more selected from the group consisting of a polyethylene oxide-based polymer compound, a polyorganosiloxane chain, and a polyoxyalkylene chain can be exemplary examples. In addition, it is also possible to use a so-called gel-type solid electrolyte in which a non-aqueous electrolytic solution is held in a polymer compound.

It is possible to use two or more kinds of the solid electrolytes in combination in a range in which the effects of the invention are not impaired.

It is preferable that the solid electrolyte in contact with the CAM according to the present embodiment be a sulfide-based solid electrolyte.

### <Method for Manufacturing Cathode Active Material for Solid Lithium Secondary Battery>

The method for manufacturing the CAM includes a coating step of coating at least a part of the surface of the LiMO using a coating device.

The method for manufacturing the CAM may further include a heating step after the coating step. Whether or not the method for manufacturing the CAM includes the heating step depends on the type and structure of the target coating material. In a case of obtaining a crystalline material requiring a high-temperature heat treatment as the coating material, it is preferable to include the heating step. On the other hand, in a case of obtaining a material having an amorphous structure, in which the target coating layer is formed at a relatively low temperature, as the coating raw material, the target coating layer may be formed by heating and drying in the coating step. In this case, the heating step after the coating step may not be provided.

### <<Coating Step>>

First, LiMO satisfying the following (A) is manufactured.

$$0.1 < {Vl}_{0.9} / {L}_{N} < 6.8 \qquad ( A )$$

(L_{N} is a BET specific surface area (unit: m²/g) of the LiMO, which is measured by a nitrogen adsorption method, and Vl_{0.9} is a water vapor adsorption amount (unit: cm³ (STP)/g) of the LiMO in a case where, in an adsorption isotherm of a water vapor adsorption method, a relative pressure p/pₒ with a saturated vapor pressure p₀ is 0.9)

In a case where the Vl_{0.9} is regarded as a water vapor amount which can be adsorbed by the LiMO, a value obtained by dividing the Vl_{0.9} by the L_{N}, which is the specific surface area of the CAM, is the water vapor amount which can be retained by the LiMO per unit specific surface area. A large value of Vl_{0.9}/L_{N} means that a large amount of water vapor can be retained.

In a case where Vl_{0.9}/L_{N} of the LiMO is less than the above-described upper limit value, liquid droplets of the coating raw material are excessively adhered to and deposited on the LiMO, and the amount of the element A contained in the CAM to be manufactured is an amount in which the resistance layer is unlikely to be formed.

In a case where Vl_{0.9}/L_{N} of the LiMO exceeds the above-described lower limit value, liquid droplets of the coating raw material in the coating step are likely to adhere to and spread on the LiMO, and thus CAM having a coating material with a high surface presence rate can be manufactured. Details of the method for manufacturing the LiMO satisfying (A) will be described later.

The (A) is preferably any one of the following (A)-1 to (A)-3.

$$1 : 0.1 < {Vl}_{0.9} / {L}_{N} < 6.8 \qquad ( A )$$

$$2 : 0.2 < {Vl}_{0.9} / {L}_{N} < 6.5 \qquad ( A )$$

$$3 : 0.5 < {Vl}_{0.9} / {L}_{N} < 6. \qquad ( A )$$

In order to coat at least a part of one particle of the LiMO, the coating raw material is brought into contact with the LiMO using a coating device provided with a two-fluid nozzle.

The coating device includes a treatment section in which the LiMO is flowable, and a two-fluid nozzle which jets, toward the LiMO, a two-fluid jet containing a liquid coating raw material containing an element A and a carrier gas.

The CAM satisfying (1) and (2) described above can be manufactured by a coating under a condition in which Q_{g}, which is a flow rate (unit: g/min) of the carrier gas, and Qₗ, which is a flow rate (unit: g/min) of the coating raw material, satisfy the following (B).

$$0.6 < {Q}_{g} / {Q}_{l} \leq 25. \qquad ( B )$$

The “Q_{g}/Qₗ” is a flow rate of the carrier gas per unit weight of the coating raw material. In a case where the value of “Q_{g}/Qₗ” is large, the liquid droplets of the coating raw material tend to be small, and in a case where the value of “Q_{g}/Qₗ” is small, the liquid droplets of the coating raw material tend to be large.

By coating under the condition satisfying (B), the coating raw material is brought into contact with the LiMO at an optimal liquid droplet diameter, and the CAM satisfying (1) and (2) described above can be manufactured.

The (B) is preferably any one of the following (B)-1 to (B)-3.

$$1 : 1. < {Q}_{g} / {Q}_{l} \leq 25. \qquad ( B )$$

$$2 : 4. < {Q}_{g} / {Q}_{l} \leq 24. \qquad ( B )$$

$$3 : 8. < {Q}_{g} / {Q}_{l} \leq 22. \qquad ( B )$$

The carrier gas is preferably a gas having nitrogen as a main component. The carrier gas containing nitrogen as a main component means a carrier gas containing 50% or more of nitrogen in the total amount of the carrier gas. A proportion of the nitrogen in the total amount of the carrier gas is preferably 60% or more and more preferably 80% or more, and may be 100%.

As the carrier gas containing nitrogen as a main component, nitrogen gas and dry air are exemplary examples, and as a component other than the nitrogen, oxygen is an exemplary example.

In the coating step, it is preferable to use a roll-to-roll flow coating device.

As the roll-to-roll flow coating device, for example, MP-01 manufactured by Powrex Corp. can be suitably used.

As the coating raw material, a lithium compound and an oxide, a hydroxide, a carbonate, a nitrate, a sulfate, a halide, a formate, an oxalate, or an alkoxide of the element A can be used.

The coating raw material is, for example, a raw material of lithium niobate. In a case of forming the coating material, a coating liquid containing the coating raw material and a solvent is used.

As a Li source of the lithium niobate, for example, Li alkoxide, Li inorganic salt, and Li hydroxide are exemplary examples.

As the Li alkoxide, for example, ethoxy lithium and methoxy lithium are exemplary examples.

As the Li inorganic salt, for example, lithium nitrate, lithium sulfate, and lithium acetate are exemplary examples. As the Li hydroxide, for example, lithium hydroxide is an exemplary example.

As a Nb source of the lithium niobate, for example, Nb alkoxide, Nb inorganic salt, Nb hydroxide, and Nb complex are exemplary examples.

As the Nb alkoxide, for example, pentaethoxy niobium, pentamethoxy niobium, penta-i-propoxy niobium, penta-n-propoxy niobium, penta-i-butoxy niobium, penta-n-butoxy niobium, and penta-sec-butoxy niobium are exemplary examples.

As the Nb inorganic salt, for example, niobium acetate and the like are exemplary examples.

As the Nb hydroxide, for example, niobium hydroxide is an exemplary example.

As the Nb complex, for example, a peroxo complex of Nb (peroxoniobate complex [Nb(O₂)₄]³⁻) is an exemplary example.

The coating liquid containing the peroxo complex of Nb has an advantage in that the amount of gas generated in the heat treatment after the coating is smaller than that in the coating liquid containing the Nb alkoxide.

As a method for preparing the coating liquid containing the peroxo complex of Nb, for example, a method of adding hydrogen peroxide water and ammonia water to a Nb oxide or a Nb hydroxide is an exemplary example. Addition amounts of the hydrogen peroxide water and the ammonia water may be appropriately adjusted so that a transparent solution (uniform solution) is obtained.

The type of solvent in the coating raw material is not particularly limited, and alcohol, water, and the like are exemplary examples.

As the alcohol, for example, methanol, ethanol, propanol, butanol, and the like are exemplary examples. For example, in a case where the coating raw material contains an alkoxide, the solvent is preferably anhydrous alcohol or dewatered alcohol. On the other hand, for example, in a case where the coating raw material contains a peroxo complex of Nb, the solvent is preferably water.

### [Heating Step]

CAM in which the coating material is formed on the surface of the LiMO is obtained by contacting the coating raw material with the LiMO and heating the coating raw material.

The heating step is preferably a step of performing heating at a temperature of 100° C. to 500° C. for 1 hour or longer.

The CAM is appropriately crushed and classified to be the CAM.

Hereinafter, an example of a method for manufacturing the LiMO will be described by dividing the method into a step of manufacturing the MCC and a step of manufacturing the LiMO.

### (Step of Manufacturing MCC)

In a case of manufacturing the LiMO, it is preferable that the MCC containing a metal other than lithium, which is a metal constituting the LiMO, be first prepared. Thereafter, the MCC is calcined with an appropriate lithium compound.

Specifically, the “MCC” is a compound containing Ni, which is an essential metal, and any one or more metals selected from Co, Mn, Al, W, B, Mo, Zn, Sn, Zr, Ga, La, Ti, Nb, or V.

As the MCC, a metal composite hydroxide or a metal composite oxide is preferable.

The MCC can be manufactured by a generally known co-precipitation method. As the co-precipitation method, it is possible to use a commonly known batch co-precipitation method or a continuous co-precipitation method. Hereinafter, the method for manufacturing the MCC will be described in detail using, as a metal, a metal composite hydroxide containing Ni, Co, and Mn as an example.

First, a nickel salt solution, a cobalt salt solution, a manganese salt solution, and a complexing agent are reacted with one another by a co-precipitation method, particularly, a continuous co-precipitation method described in JP-A-2002-201028, thereby manufacturing a metal composite hydroxide represented by Ni_{(1-y-z)}Co_{y}Mn_{z}(OH)₂ (in the formula, y+z=1).

A nickel salt which is a solute of the above-described nickel salt solution is not particularly limited, and, for example, one or more of nickel sulfate, nickel nitrate, nickel chloride, and nickel acetate can be used.

As a cobalt salt which is a solute of the above-described cobalt salt solution, for example, one or more of cobalt sulfate, cobalt nitrate, cobalt chloride, and cobalt acetate can be used.

As a manganese salt which is a solute of the above-described manganese salt solution, for example, one or more of manganese sulfate, manganese nitrate, manganese chloride, and manganese acetate can be used.

The above-described metal salt is used in a proportion corresponding to the compositional ratio of NiₐCo_{b}Mn_{c}(OH)₂. That is, the amount of each of the metal salts used is set so that the molar ratio of nickel in the solute of the nickel salt solution, cobalt in the solute of the cobalt salt solution, and Mn in the solute of the manganese salt solution is to be 1−y−z:y:z corresponding to the compositional ratio of Ni_{(1-y-z)}Co_{y}Mn_{z}(OH)₂.

In addition, a solvent of the nickel salt solution, the cobalt salt solution, and the manganese salt solution is water. That is, the solvent of the nickel salt solution, the cobalt salt solution, and the manganese salt solution is an aqueous solution.

The complexing agent is a compound capable of forming a complex with a nickel ion, a cobalt ion, and a manganese ion in an aqueous solution. As the complexing agent, for example, ammonium ion donors (ammonium salts such as ammonium hydroxide, ammonium sulfate, ammonium chloride, ammonium carbonate, and ammonium fluoride), hydrazine, ethylenediaminetetraacetic acid, nitrilotriacetic acid, uracildiacetic acid, and glycine are exemplary examples.

In a case of using the complexing agent, the amount of the complexing agent contained in the mixed solution containing the nickel salt solution, the optional metal salt solution, and the complexing agent is, for example, a molar ratio of more than 0 and 2.0 or less with respect to the total number of moles of the metal salt. In a case of using the complexing agent, the amount of the complexing agent contained in the mixed solution containing the nickel salt solution, the cobalt salt solution, the manganese salt solution, and the complexing agent is, for example, a molar ratio of more than 0 and 2.0 or less with respect to the total number of moles of the metal salt.

In the co-precipitation method, in order to adjust the pH value of the mixed solution containing the nickel salt solution, the optional metal salt solution, and the complexing agent, an alkali metal hydroxide is added to the mixed solution before the pH of the mixed solution changes from alkaline to neutral. The alkali metal hydroxide is, for example, sodium hydroxide or potassium hydroxide.

The pH value in the present specification is defined as a value measured in a case where the temperature of the mixed solution is 40° C. The pH of the mixed solution is measured in a case where the temperature of the mixed solution sampled from a reaction vessel reaches 40° C.

In a case where the complexing agent in addition to the nickel salt solution, the cobalt salt solution, and the manganese salt solution described above is continuously supplied to the reaction vessel, Ni, Co, and Mn react with each other to form Ni_{(1-y-z)}Co_{y}Mn_{z}(OH)₂.

During the reaction, the temperature of the reaction vessel is controlled, for example, within a range of 20° C. to 80° C., preferably 30° C. to 70° C.

In addition, during the reaction, the pH value in the reaction vessel is controlled, for example, within a range of pH 9 to pH 13, preferably pH 11 to pH 13.

The substances in the reaction vessel are appropriately stirred and mixed together.

As the reaction vessel which is used in the continuous co-precipitation method, an overflow type reaction vessel can be used to separate the formed reaction precipitate.

By appropriately controlling the concentrations of the metal salts in the metal salt solutions supplied to the reaction vessel, the stirring speed, the reaction temperature, the reaction pH, calcining conditions described later, and the like, it is possible to control various physical properties of the LiMO which is finally obtained, such as a secondary particle diameter and a pore radius.

In addition to the control of the above-described conditions, an oxidation state of a reaction product to be obtained may be controlled by supplying a variety of gases, for example, an inert gas such as nitrogen, argon, or carbon dioxide, an oxidizing gas such as air or oxygen, or a gas mixture thereof to the reaction vessel.

As a compound (oxidizing agent) which oxidizes the reaction product to be obtained, it is possible to use peroxides such as hydrogen peroxide, peroxide salts such as permanganate, perchlorates, hypochlorites, nitric acid, halogens, ozone, or the like.

As a compound which reduces the reaction product to be obtained, it is possible to use organic acids such as oxalic acid and formic acid, sulfites, hydrazines, or the like.

In detail, the inside of the reaction vessel may be an inert atmosphere. In a case where the inside of the reaction vessel is an inert atmosphere, a metal which is more easily oxidized than nickel among the metals contained in the mixed solution is prevented from aggregating earlier than nickel. Therefore, a uniform metal composite hydroxide can be obtained.

In addition, the inside of the reaction vessel may be an appropriate oxidizing atmosphere. The oxidizing atmosphere may be an oxygen-containing atmosphere formed by mixing an oxidizing gas into an inert gas, and when the inside of the reaction vessel, in which an oxidizing agent may be present in an inert gas atmosphere, is an appropriate oxidizing atmosphere, a transition metal which is contained in the liquid mixture is appropriately oxidized, which makes it easy to control the form of the metal composite oxide.

As oxygen or the oxidizing agent in the oxidizing atmosphere, a sufficient number of oxygen atoms need to be present in order to oxidize the transition metal.

In a case where the oxidizing atmosphere is an oxygen-containing atmosphere, the atmosphere in the reaction vessel can be controlled by a method in which an oxidizing gas is bubbled or the like in the liquid mixture, which aerates the oxidizing gas into the reaction vessel.

After the above-described reaction, the obtained reaction precipitate is washed with water and dried, whereby the MCC is obtained. In the present embodiment, a nickel cobalt manganese hydroxide is obtained as the MCC. In addition, in a case where the reaction precipitate is washed with water only, and foreign matter derived from the mixed solution remains, the reaction precipitate may be washed with weak acid water or an alkaline solution, as necessary. As the alkaline solution, an aqueous solution containing sodium hydroxide or potassium hydroxide is an exemplary example.

In the above-described example, the nickel cobalt manganese composite hydroxide is manufactured, but a nickel cobalt manganese composite oxide may be prepared.

For example, the nickel cobalt manganese composite oxide can be prepared by oxidizing the nickel cobalt manganese composite hydroxide. Regarding the calcining time for oxidation, the total time taken while the temperature begins to be raised and reaches the calcining temperature and the holding of the composite metal hydroxide at the calcining temperature ends is preferably set to 1 to 30 hours.

The temperature rising rate in the heating step until the highest holding temperature is reached is preferably 180° C./hour or more, more preferably 200° C./hour or more, and particularly preferably 250° C./hour or more.

The highest holding temperature in the present specification is the highest holding temperature of the atmosphere in a calcining furnace in a calcining step and means the calcining temperature in the calcining step. In the case of a main calcining step having a plurality of heating steps, the highest holding temperature means the highest temperature in each heating step.

The temperature rising rate in the present specification is calculated from the time taken while the temperature begins to be raised and reaches the highest holding temperature in a calcining device and a temperature difference between the temperature in the calcining furnace of the calcining device at the time of beginning to raise the temperature and the highest holding temperature.

### (Step of Manufacturing LiMO)

In the step, after drying the metal composite oxide or metal composite hydroxide described above, the metal composite oxide or metal composite hydroxide is mixed with a lithium compound.

As the lithium compound, it is possible to use any one of lithium carbonate, lithium nitrate, lithium acetate, lithium hydroxide, lithium oxide, lithium chloride, and lithium fluoride, or a mixture of two or more thereof. Among these, any one or both of lithium hydroxide and lithium carbonate are preferable.

In a case where the lithium hydroxide contains lithium carbonate as an impurity, the content of the lithium carbonate in the lithium hydroxide is preferably 5% by mass or less.

Drying conditions of the metal composite oxide or metal composite hydroxide described above are not particularly limited. The drying conditions may be, for example, any of the following conditions 1) to 3).

1) Conditions in which the metal composite oxide or metal composite hydroxide is not oxidized or reduced;
specifically, a drying condition in which an oxide remains as an oxide as it is or a drying condition in which a hydroxide remains as a hydroxide as it is.

2) a condition in which the metal composite hydroxide is oxidized; specifically, a drying condition in which the hydroxide is oxidized to an oxide.

3) a condition in which the metal composite oxide is reduced; specifically, a drying condition in which the oxide is reduced to a hydroxide.

Under the condition in which oxidation or reduction do not occur, an inert gas such as nitrogen, helium or argon may be used as the atmosphere during the drying.

Under the condition in which the hydroxide is oxidized, oxygen or air may be used as the atmosphere during the drying.

In addition, under the condition in which the metal composite oxide is reduced, a reducing agent such as hydrazine and sodium sulfite may be used in the inert gas atmosphere during the drying.

After the drying, the metal composite oxide or metal composite hydroxide may be classified as appropriate.

The above-described lithium compound and the metal composite compound are used in consideration of the compositional ratio of the final target product. For example, in a case where the nickel-cobalt-manganese composite compound is used, the lithium compound and the metal composite compound are used in a proportion corresponding to the compositional ratio of LiNi_{(1-y-z)}Co_{y}Mn_{z}O₂ (in the formula, y+z=1). In addition, in a case where lithium is excessive (the content molar ratio is more than 1) in the LiMO, which is the final target product, the lithium compound and the metal composite compound are mixed at a proportion of a molar ratio of lithium contained in the lithium compound to the metal element contained in the metal composite compound being more than 1.

The mixture of the nickel-cobalt-manganese composite compound and the lithium compound is calcined to obtain a lithium-nickel-cobalt-manganese composite oxide. In the calcining, dry air, an oxygen atmosphere, an inert atmosphere, or the like is used depending on a desired composition, and a plurality of heating steps are carried out as necessary.

As a holding temperature, specifically, a range of 200° C. to 1150° C. is an exemplary example, preferably 300° C. to 1050° C. and more preferably 500° C. to 1000° C.

In addition, as a time for holding at the holding temperature, 0.1 to 20 hours is an exemplary example, preferably 0.5 to 0 hours. A temperature rising rate up to the holding temperature is usually 50 to 400° C./hour, and a temperature lowering rate from the above-described holding temperature to room temperature is usually 10 to 400° C./hour. In addition, as the calcining atmosphere, it is possible to use air, oxygen, nitrogen, argon, or a mixed gas thereof.

The mixture of the nickel-cobalt-manganese composite compound and the lithium compound may be subjected to a plurality of calcining steps at different calcining temperatures, and it is preferable to perform primary calcining, and secondary calcining at a higher temperature than the primary calcining.

The calcining temperature of the primary calcining may be set to, for example, 500° C. to 700° C. The calcining time of the primary calcining may be set to, for example, 3 to 7 hours.

The calcining temperature of the secondary calcining is preferably 750° C. to 950° C. and more preferably 800° C. to 900° C. The calcining time of the secondary calcining may be set to, for example, 3 to 7 hours.

In the secondary calcining, the temperature rising rate in the heating step until the highest holding temperature is reached is preferably 115° C./hour or more, more preferably 120° C./hour or more, and particularly preferably 125° C./hour or more.

By setting the calcining temperature and the temperature rising rate in the secondary calcining to be within the above-described ranges, the LiMO satisfying (A) is easily obtained.

In the present embodiment, it is preferable that the obtained calcined product after the calcining be washed with pure water, an alkaline washing liquid, or the like as a washing liquid.

As the alkaline washing liquid, for example, aqueous solutions of one or more anhydrides selected from the group consisting of LiOH (lithium hydroxide), NaOH (sodium hydroxide), KOH (potassium hydroxide), Li₂CO₃ (lithium carbonate), Na₂CO₃ (sodium carbonate), K₂CO₃ (potassium carbonate), and (NH₄)₂CO₃ (ammonium carbonate) and aqueous solutions of a hydrate of the above-described anhydride are exemplary examples. In addition, as an alkali, it is also possible to use ammonia.

As a method for bringing the washing liquid and the calcined product into contact with each other in the washing step, a method in which the calcined product is poured into and stirred in each washing liquid; a method in which each washing liquid is applied as shower water to the calcined product; and a method in which the calcined product is poured into and stirred in a washing liquid, the calcined product is separated from the washing liquid, and each washing liquid is applied as shower water to the separated calcined product are exemplary examples.

The temperature of the washing liquid used for the washing is preferably 15° C. or lower, more preferably 10° C. or lower, and still more preferably 8° C. or lower. By controlling the temperature of the washing liquid within the above-described range, that is, a temperature at which the washing liquid does not freeze, the LiMO satisfying (A) is easily obtained.

### (Arbitrary Drying Step)

It is preferable that the obtained calcined product after the calcining or the calcined product after the washing be dried. By drying after the calcining, it is possible to reliably remove moisture remaining in the fine pores. The moisture remaining in the fine pores causes deterioration of the solid electrolyte in a case of manufacturing the electrode. By drying after the calcining to remove the moisture remaining in the fine pores, the deterioration of the solid electrolyte can be prevented.

A drying method after the calcining is not particularly limited as long as the moisture remaining in the LiMO can be removed.

As the drying method after the calcining, for example, a vacuum drying treatment under vacuum or a drying treatment using a hot air dryer is preferable.

The drying temperature is, for example, preferably 80° C. to 140° C.

The drying time is not particularly limited as long as the moisture can be removed, and for example, 5 to 12 hours is an exemplary example.

### <Solid Lithium Secondary Battery>

Next, a solid lithium secondary battery including the CAM according to the aspect of the present invention will be described.

FIG. 2 is a schematic view showing an example of a solid lithium secondary battery. A solid lithium secondary battery 1000 shown in FIG. 2 has a laminate 100 having a cathode 110, an anode 120, and a solid electrolyte layer 130, and an exterior body 200 accommodating the laminate 100. In addition, the solid lithium secondary battery 1000 may have a bipolar structure in which the CAM and an anode active material are disposed on both sides of a current collector. As specific examples of the bipolar structure, for example, the structures described in JP-A-2004-95400 are exemplary examples. A material which configures each member will be described below.

The solid lithium secondary battery 1000 further has an insulator (not shown) which insulates the laminate 100 and the exterior body 200 from each other and a sealant (not shown) which seals an opening portion 200a of the exterior body 200.

As the exterior body 200, a container formed of a highly corrosion-resistant metal material such as aluminum, stainless steel or nickel-plated steel can be used. In addition, as the exterior body 200, a container obtained by processing a laminate film having at least one surface on which a corrosion resistant process has been carried out into a bag shape can also be used.

As the shape of the solid lithium secondary battery 1000, for example, shapes such as a coin-type, a button type, a paper-type (or a sheet-type), a cylindrical type, a square shape, and a laminate type (pouch type) can be exemplary examples.

As an example of the solid lithium secondary battery 1000, a form in which one laminate 100 is provided is shown in the drawings, but the present embodiment is not limited thereto. The solid lithium secondary battery 1000 may have a configuration in which the laminate 100 is used as a unit cell and a plurality of unit cells (laminates 100) is sealed inside the exterior body 200.

Hereinafter, each configuration will be described in order.

### (Cathode)

The cathode 110 of the present embodiment has a cathode active material layer 111 and a cathode current collector 112.

The cathode active material layer 111 contains CAM, which is one aspect of the present invention described above, and a solid electrolyte. In addition, the cathode active material layer 111 may contain a conductive material and a binder.

### (Solid Electrolyte)

The solid electrolyte is as described above.

### (Conductive Material and Binder)

As the conductive material in the cathode active material layer 111, a carbon material can be used. As the carbon material, graphite powder, carbon black (for example, acetylene black), a fibrous carbon material, and the like can be exemplary examples.

A proportion of the conductive material in the cathode material mixture is preferably 5 to 20 parts by mass with respect to 100 parts by mass of the CAM.

As the binder, a thermoplastic resin can be used. As the thermoplastic resin, polyimide resins; fluororesins such as polyvinylidene fluoride (hereinafter, may be referred to as PVdF) and polytetrafluoroethylene; polyolefin resins such as polyethylene and polypropylene, and the resins described in WO2019/098384A1 or US2020/0274158A1 can be exemplary examples.

### (Cathode Current Collector)

As the cathode current collector 112 in the cathode 110, a strip-shaped member formed of a metal material such as Al, Ni, and stainless steel as a forming material can be used.

As a method for supporting the cathode active material layer 111 with the cathode current collector 112, a method in which the cathode active material layer 111 is formed by pressurization on the cathode current collector 112 is an exemplary example. A cold press or a hot press can be used for the pressurization.

In addition, the cathode active material layer 111 may be supported with the cathode current collector 112 by preparing a paste of a mixture of the CAM, the solid electrolyte, the conductive material, and the binder using an organic solvent to produce a cathode material mixture, applying and drying the obtained cathode material mixture on at least one surface of the cathode current collector 112, and fixing the cathode material mixture by pressing.

In addition, the cathode active material layer 111 may be supported with the cathode current collector 112 by preparing a paste of a mixture of the CAM, the solid electrolyte, and the conductive material using an organic solvent to produce a cathode material mixture, applying and drying the obtained cathode material mixture on at least one surface of the cathode current collector 112, and calcining the cathode material mixture.

As the organic solvent which can be used in the cathode material mixture, N-methyl-2-pyrrolidone (hereinafter, may be referred to as NMP) is an exemplary example.

As the method for applying the cathode material mixture to the cathode current collector 112, a slit die coating method, a screen coating method, a curtain coating method, a knife coating method, a gravure coating method, and an electrostatic spraying method are exemplary examples.

The cathode 110 can be manufactured by the method mentioned above. As a specific combination of materials used for the cathode 110, a combination of the CAM described in the present embodiment and materials described in Tables 1 to 3 is an exemplary example.

TABLE 1

| Solid electrolyte | Binder | Conductive material |
|---|---|---|
| Perovskite-type | Polyimide- | Graphite powder |
| oxide | based resin | Carbon black |
| | | Fibrous carbon material |
| | Fluororesin | Graphite powder |
| | | Carbon black |
| | | Fibrous carbon material |
| | Polyolefin | Graphite powder |
| | resin | Carbon black |
| | | Fibrous carbon material |
| NASICON-type | Polyimide- | Graphite powder |
| oxide | based resin | Carbon black |
| | | Fibrous carbon material |
| | Fluororesin | Graphite powder |
| | | Carbon black |
| | | Fibrous carbon material |
| | Polyolefin | Graphite powder |
| | resin | Carbon black |
| | | Fibrous carbon material |
| LISICON-type | Polyimide- | Graphite powder |
| oxide | based resin | Carbon black |
| | | Fibrous carbon material |
| | Fluororesin | Graphite powder |
| | | Carbon black |
| | | Fibrous carbon material |
| | Polyolefin | Graphite powder |
| | resin | Carbon black |
| | | Fibrous carbon material |
| Garnet-type oxide | Polyimide- | Graphite powder |
| | based resin | Carbon black |
| | | Fibrous carbon material |
| | Fluororesin | Graphite powder |
| | | Carbon black |
| | | Fibrous carbon material |
| | Polyolefin | Graphite powder |
| | resin | Carbon black |
| | | Fibrous carbon material |

TABLE 2

| Solid electrolyte | Binder | Conductive material |
|---|---|---|
| Li₂S—P₂S₅-based | Polyimide- | Graphite powder |
| compound | based resin | Carbon black |
| | | Fibrous carbon material |
| | Fluororesin | Graphite powder |
| | | Carbon black |
| | | Fibrous carbon material |
| | Polyolefin | Graphite powder |
| | resin | Carbon black |
| | | Fibrous carbon material |
| Li₂S—SiS₂-based | Polyimide- | Graphite powder |
| compound | based resin | Carbon black |
| | | Fibrous carbon material |
| | Fluororesin | Graphite powder |
| | | Carbon black |
| | | Fibrous carbon material |
| | Polyolefin | Graphite powder |
| | resin | Carbon black |
| | | Fibrous carbon material |
| Li₂S—GeS₂-based | Polyimide- | Graphite powder |
| compound | based resin | Carbon black |
| | | Fibrous carbon material |
| | Fluororesin | Graphite powder |
| | | Carbon black |
| | | Fibrous carbon material |
| | Polyolefin | Graphite powder |
| | resin | Carbon black |
| | | Fibrous carbon material |
| Li₂S—B₂S₃-based | Polyimide- | Graphite powder |
| compound | based resin | Carbon black |
| | | Fibrous carbon material |
| | Fluororesin | Graphite powder |
| | | Carbon black |
| | | Fibrous carbon material |
| | Polyolefin | Graphite powder |
| | resin | Carbon black |
| | | Fibrous carbon material |

TABLE 3

| Solid electrolyte | Binder | Conductive material |
|---|---|---|
| LiI—Si₂S—P₂S₅- | Polyimide- | Graphite powder |
| based compound | based resin | Carbon black |
| | | Fibrous carbon material |
| | Fluororesin | Graphite powder |
| | | Carbon black |
| | | Fibrous carbon material |
| | Polyolefin | Graphite powder |
| | resin | Carbon black |
| | | Fibrous carbon material |
| LiI—Li₂S—P₂O₅- | Polyimide- | Graphite powder |
| based compound | based resin | Carbon black |
| | | Fibrous carbon material |
| | Fluororesin | Graphite powder |
| | | Carbon black |
| | | Fibrous carbon material |
| | Polyolefin | Graphite powder |
| | resin | Carbon black |
| | | Fibrous carbon material |
| LiI—Li₃PO₄—P₂S₅- | Polyimide- | Graphite powder |
| based compound | based resin | Carbon black |
| | | Fibrous carbon material |
| | Fluororesin | Graphite powder |
| | | Carbon black |
| | | Fibrous carbon material |
| | Polyolefin | Graphite powder |
| | resin | Carbon black |
| | | Fibrous carbon material |
| Li₁₀GeP₂S₁₂- | Polyimide- | Graphite powder |
| based compound | based resin | Carbon black |
| | | Fibrous carbon material |
| | Fluororesin | Graphite powder |
| | | Carbon black |
| | | Fibrous carbon material |
| | Polyolefin | Graphite powder |
| | resin | Carbon black |
| | | Fibrous carbon material |

### (Anode)

The anode 120 has an anode active material layer 121 and the anode current collector 122.

The anode active material layer 121 contains an anode active material. In addition, the anode active material layer 121 may contain a solid electrolyte and a conductive material. As the anode active material, the anode current collector, the solid electrolyte, the conductive material, and a binder, those described above can be used.

As a method for supporting the anode active material layer 121 by the anode current collector 122, similar to the case of the cathode 110, a method in which the anode active material layer 121 is formed by pressurization, a method in which a paste-like anode material mixture containing an anode active material is applied and dried on the anode current collector 122 and the anode active material layer 121 is compressed by pressing, and a method in which a paste-like anode material mixture containing an anode active material is applied, dried and then calcined on the anode current collector 122 are exemplary examples.

### (Solid Electrolyte Layer)

The solid electrolyte layer 130 has the above-described solid electrolyte.

The solid electrolyte layer 130 can be formed by depositing a solid electrolyte of an inorganic substance on the surface of the cathode active material layer 111 in the above-described cathode 110 by a sputtering method.

In addition, the solid electrolyte layer 130 can be formed by applying and drying a paste-like mixture containing a solid electrolyte on the surface of the cathode active material layer 111 in the above-described cathode 110. The solid electrolyte layer 130 may be formed by pressing the dried paste-like mixture and further pressurizing the paste-like mixture by a cold isostatic pressure method (CIP).

The laminate 100 can be manufactured by laminating the anode 120 on the solid electrolyte layer 130 provided on the cathode 110 as described above using a known method such that the anode active material layer 121 comes into contact with the surface of the solid electrolyte layer 130.

In the lithium secondary battery having the above-described configuration, since the CAM according to the present embodiment is provided, it is possible to provide a solid lithium secondary battery having a high utilization rate of the cathode material.

### [Measurement of Utilization Rate]

The operations of <Manufacturing of all-solid lithium-ion secondary battery> are carried out in a glove box with an argon atmosphere.

### (Production of Cathode Mixture)

1,000 mg of the cathode active material, 0.0543 g of a conductive material (Acetylene Black), and 8.6 mg of a solid electrolyte (manufactured by MSE CO., LTD., Li₆PS₅Cl) are weighed. The cathode active material, the conductive material, and the solid electrolyte are mixed in a mortar for 15 minutes to produce a cathode mixture.

### (Production of Battery Cell)

Next, 150 mg of the solid electrolyte (manufactured by MSE CO., LTD., Li₆PS₅Cl) is charged into a battery cell for an all-solid battery (HSSC-05 manufactured by Hohsen Corp.; electrode size: φ10 mm), and the cell is pressurized to a load of 29.3 kN with a uniaxial press machine to form a solid electrolyte layer.

Next, the pressure is released, and the upper punch is pulled out, and 14.4 mg of the above-described cathode mixture is put on the solid electrolyte layer molded in the cell. An SUS foil (φ10 mm×0.5 mm thick) is inserted thereon, and the upper punch is inserted again and pushed in by hand.

A lithium metal foil (thickness: 50 μm) and an indium foil (thickness: 100 μm) punched out with a diameter of φ8.5 mm are sequentially inserted on the solid electrolyte layer as an anode.

Furthermore, an SUS foil having a diameter of φ10 mm and a thickness of 50 μm is inserted on the anode, a punch of the battery cell is inserted, and the cell is pressurized up to a load of 512 kN with a uniaxial press, and after the pressure is released, a screw of the case is tightened so that the internal restraint pressure of the cell is set to 200 MPa.

A glass desiccator in which an electrical wiring is connected inside and outside while having confidentiality is prepared, the above-described battery cell is put into the glass desiccator, each electrode of the cell and the wiring of the desiccator are connected, and the glass desiccator is sealed to produce a sulfide-based all-solid lithium-ion secondary battery. The completed sulfide-based all-solid lithium-ion secondary battery is taken out from the argon atmosphere glove box, and the following evaluation is performed.

### <Charging and Discharging Test>

Using the all-solid battery produced by the above-described method, a charging and discharging test is carried out under the following conditions.

### (Charging and Discharging Conditions)

Test temperature: 60° C.

### (First Charging and Discharging (Initial))

Charging maximum voltage: 3.68 V; Charging current density: 0.1 CA, Cutoff current density: 0.02 C; Constant current-constant voltage charging
Discharging minimum voltage: 1.88 V; Discharging current density: 0.1 CA; Constant current discharging

### (Second Charging and Discharging)

Charging maximum voltage: 3.68 V; Charging current density: 0.1 CA, Cutoff current density: 0.02 C; Constant current-constant voltage charging
Discharging minimum voltage: 1.88 V; Discharging current density: 0.1 CA; Constant current discharging

The second discharge capacity of the all-solid lithium secondary battery is obtained by the above-described method.

### <Manufacturing of Liquid-Type Lithium Secondary Battery>

### (Production of Cathode for Lithium Secondary Battery)

The CAM, a conductive material (Acetylene Black), and a binder (PVdF) are added and kneaded in a proportion of CAM:conductive material:binder=92:5:3 (mass ratio) to prepare a paste-like cathode material mixture. During the preparation of the cathode material mixture, N-methyl-2-pyrrolidone is used as an organic solvent.

The obtained cathode material mixture is applied to an Al foil having a thickness of 40 μm, which is to serve as a current collector, and dried in a vacuum at 150° C. for 8 hours, thereby obtaining a cathode for lithium secondary battery. The electrode area of the cathode for lithium secondary battery is set to 1.65 cm².

### (Production of Lithium Secondary Battery (Coin-Type Half-Cell))

The following operation is carried out in a glove box under an argon atmosphere.

The cathode for lithium secondary battery, produced in (Production of cathode for lithium secondary battery), is placed on the lower lid of a part for a coin-type battery R2032 (manufactured by Hohsen Corp.) with the aluminum foil surface facing downward, and a separator (polyethylene porous film) is placed thereon.

300 μl of an electrolytic solution is injected therein. As the electrolytic solution, a solution obtained by dissolving LiPF₆ in a mixed solution of ethylene carbonate, dimethyl carbonate, and ethyl methyl carbonate at a volume ratio of 30:35:35 with a proportion of 1.0 mol/l is used.

Next, lithium metal is used as an anode, and the anode is placed on the upper side of the laminated film separator. An upper lid is placed through a gasket and caulked using a caulking machine, thereby producing a lithium secondary battery (coin-type half-cell CR2032; hereinafter, may be referred to as “half-cell”).

### <Charging and Discharging Test>

Using the liquid-type lithium secondary battery produced by the above-described method, a charging and discharging test is carried out under the following conditions.

### (Charging and Discharging Conditions)

Test temperature: 25° C.

### (First Charging and Discharging (Initial))

Charging maximum voltage: 4.3 V; Charging current density: 0.2 CA, Cutoff current density: 0.05 C; Constant current-constant voltage charging
Discharging minimum voltage: 2.5 V; Discharging current density: 0.2 CA; Constant current discharging

The initial charge capacity of the liquid-type lithium secondary battery is obtained by the above-described method.

### (Calculation of Utilization Rate)

$$Utilization rate ( \% ) = Second discharge capacity of all - solid lithium secondary battery / Initial charge capacity of liquid - type lithium secondary battery \times 100$$

### EXAMPLES

### <Composition Analysis>

The compositional analysis of the CAM and the LiMO was carried out by the method described in [Measurement by ICP emission spectroscopy] above.

### <Measurement of Battery Performance>

As the battery performance of the all-solid lithium secondary battery using the CAM, the utilization rate was measured by the method described in [Measurement of utilization rate] above.

### <Measurement of Surface Presence Rate of Element A>

The surface presence rate of the element A was measured by the method described in [Method for measuring surface presence rate of element A] above.

<Acquisition of Va_{0.5}, Va_{0.9}, Vd_{0.5}, and Vl_{0.9}>

Va_{0.5}, Va_{0.9}, and Vd_{0.5} of the CAM were acquired by [Acquisition method of adsorption isotherm and desorption isotherm obtained by measurement using water vapor adsorption method] described above.

Vl_{0.9} of the LiMO was acquired by [Acquisition method of adsorption isotherm and desorption isotherm obtained by measurement using water vapor adsorption method] described above.

<Acquisition of S_{H}, S_{N}, and L_{N}>

S_{H} and S_{N} of the CAM were acquired by the method described in [Method for measuring BET specific surface area] above, in which nitrogen or water vapor was used as the adsorbed gas.

L_{N} of the LiMO was acquired by the method described in [Method for measuring BET specific surface area] above, in which water vapor was used as the adsorbed gas.

From the obtained Va_{0.5}, Va_{0.9}, Vd_{0.5}, Vl_{0.9}, S_{H}, S_{N}, and L_{N}, “(Va_{0.9}/S_{N})×(Vd_{0.5}−Va_{0.5})/Va_{0.9}” and “(S_{H}/S_{N})×(Vd_{0.5}−Va_{0.5})/Va_{0.9}” were calculated for the CAM, and “Vl_{0.9}/L_{N}” was calculated for the LiMO.

### Example 1

### (Production of CAM1)

### [Step of Producing LiMO]

After water was poured into a reaction vessel equipped with a stirrer and an overflow pipe, a sodium hydroxide aqueous solution was added thereto, and the liquid temperature was retained at 50° C.

A nickel sulfate aqueous solution, a cobalt sulfate aqueous solution, and a manganese sulfate aqueous solution were mixed with an atomic ratio of Ni, Co, and Mn of 0.58:0.20:0.22, thereby preparing a mixed raw material solution 1.

Next, the mixed raw material solution 1 was continuously added to the reaction vessel under stirring, using an ammonium sulfate aqueous solution as a complexing agent. A sodium hydroxide aqueous solution was added dropwise to the solution in the reaction vessel under a condition in which the pH of the solution was 12.1 (in a case where the temperature of the aqueous solution was 40° C.), thereby obtaining nickel-cobalt-manganese composite hydroxide particles.

The obtained nickel-cobalt-manganese composite hydroxide particles were washed, dewatered by a centrifugal separator, washed, dewatered, and dried at 105° C. for 20 hours to obtain a nickel-cobalt-manganese composite hydroxide 1.

The nickel-cobalt-manganese-composite hydroxide 1 and a lithium hydroxide monohydrate powder were weighed and mixed in a proportion of Li/(Ni+Co+Mn)=1.03 to obtain a mixture 1.

Thereafter, the mixture 1 was primary calcined at 650° C. for 5 hours in an oxygen atmosphere.

Next, secondary calcining was performed at 850° C. for 5 hours in an oxygen atmosphere to obtain a secondary calcined product.

The obtained secondary calcined product was crushed with a mass colloider-type crusher to obtain a crushed product.

The operating conditions and the mass colloider-type crusher device used were as follows.

### (Operating Conditions of Mass Colloider-Type Crusher)

Device used: MKCA6-5J manufactured by MASUKO SANGYO CO., LTD.
Rotation speed: 1,200 rpm
Interval: 100 μm

The obtained crushed product was sieved using a turbo screener to obtain LiMO1. The operating conditions and sieving conditions of the turbo screener were as follows.

### [Operating Conditions and Sieving Conditions of Turbo Screener]

The obtained crushed product was sieved using a turbo screener (TS125×200 type, manufactured by FREUND TURBO.). The operating conditions of the turbo screener were as follows.

### (Operating Conditions of Turbo Screener)

Screen used: 45 μm mesh; Blade rotation speed: 1,800 rpm; Supply rate: 50 kg/hour

### (Evaluation of LiMO1)

In the LiMO1, L_{N} was 0.897 m²/g, and Vl_{0.9}/L_{N} was 2.580. The LiMO1 had a layered structure.

### [Step of Forming Coating Material]

### (Step of Preparing Coating Liquid)

355.89 g of H₂O₂ water having a concentration of 30% by mass, 404.63 g of pure water, and 18.20 g of niobium oxide hydrate Nb₂O₅·nH₂O (niobium oxide manufactured by Mitsuwa Chemicals Co., Ltd.) were mixed with each other. Next, 35.92 g of ammonia water having a concentration of 28% by mass was added thereto, and the mixture was stirred. Furthermore, 5.21 g of LiOH·H₂O was added thereto to obtain a coating liquid 1 containing a niobium peroxy complex and lithium.

### (Coating Step)

A roll-to-roll flow coating device (MP-01, manufactured by Powrex Corp.) was used in the coating step. 500 g of the powder of the LiMO1 was subjected to a pre-treatment of drying at 120° C. for 10 hours in a vacuum atmosphere.

Thereafter, the surface of the LiMO1 was coated with the coating liquid 1 under the following conditions.
Carrier gas: carbon dioxide-free dried air (nitrogen content: 78%)
Air supply volume: 0.23 m³/min
Air temperature: 200° C.
Spray type: two-fluid nozzle (model: MPXII-LP)
Liquid flow rate of two-fluid nozzle (Qₗ): 2.70 g/min
Air flow rate of two-fluid nozzle (Q_{g}): 38.9 g/min
Rotor rotation speed: 400 rpm
Air pressure of two-fluid nozzle: 0.07 MPa
Q_{g}/Qₗ: 14.4

### (Calcining Step)

The coating liquid 1 was brought into contact with the LiMO1, and heat-treated at 200° C. for 5 hours in an oxygen atmosphere to obtain CAM1.

### [Evaluation of CAM1]

The CAM1 contained a coating material that coated at least a part of the surface of the LiMO particles. The coating material had Nb.

In the CAM1, a surface presence rate of the element A was 86.6%, (Va_{0.9}/S_{N})×(Vd_{0.5}−Va_{0.5})/Va_{0.9} was 2.64, and (S_{H}/S_{N})×(Vd_{0.5}−Va_{0.5})/Va_{0.9} was 1.93.

As a result of the composition analysis of the CAM1, in a case of being represented by a compositional formula of Li[Liₓ(Ni_{(1-y-z-w)}Co_{y}Mn_{z}M_{w})₁₋ₓ]O₂, x=0.07, y=0.20, z=0.21, M=Nb, and w=0.02.

An initial charge capacity of the liquid-type lithium secondary battery of the CAM1 was 191 mAh/g, and a second discharge capacity of the all-solid lithium secondary battery was 153 mAh/g. A utilization rate calculated from these values was 80%.

### Example 2

### (Production of CAM2)

### [Step of Producing LiMO]

LiMO1 was obtained by the same method as described above.

### [Step of Forming Coating Layer]

### (Step of Preparing Coating Liquid)

177.42 g of H₂O₂ water having a concentration of 30% by mass, 201.33 g of pure water, and 9.07 g of niobium oxide hydrate Nb₂O₅·nH₂O (niobium oxide manufactured by Mitsuwa Chemicals Co., Ltd.) were mixed with each other. Next, 17.98 g of ammonia water having a concentration of 28% by mass was added thereto, and the mixture was stirred. Furthermore, 2.59 g of LiOH·H₂O was added thereto to obtain a coating liquid 2 containing a niobium peroxy complex and lithium.

The coating liquid 2 was brought into contact with the LiMO1 by the same method as in Example 1, except that the coating liquid 2 was used.

### (Heating Step)

The coating liquid 2 was brought into contact with the LiMO1, and heat-treated at 200° C. for 5 hours in an oxygen atmosphere to obtain CAM2.

### [Evaluation of CAM2]

The CAM2 contained a coating material that coated at least a part of the surface of the LiMO particles. The coating material had Nb.

In the CAM2, a surface presence rate of the element A was 70.5%, (Va_{0.9}/S_{N})×(Vd_{0.5}−Va_{0.5})/Va_{0.9} was 1.42, and (S_{H}/S_{N})×(Vd_{0.5}−Va_{0.5})/Va_{0.9} was 1.27.

As a result of the composition analysis of the CAM2, in a case of being represented by a compositional formula of Li[Liₓ(Ni_{(1-y-z-w)}Co_{y}Mn_{z}M_{w})₁₋ₓ]O₂, x=0.09, y=0.20, z=0.22, M=Nb, and w=0.01.

An initial charge capacity of the liquid-type lithium secondary battery of the CAM2 was 191 mAh/g, and a second discharge capacity of the all-solid lithium secondary battery was 172 mAh/g. A utilization rate calculated from these values was 90%.

### Example 3

### (Production of CAM3)

### [Step of Producing LiMO]

LiMO2 was obtained by the same method as in Example 1, except that, as the nickel-cobalt-manganese complex hydroxide 1, a cathode precursor material having Ni/Co/Mn=60/20/20 and D50 of 3 μm, manufactured by GUANGDONG KINLONG INDUSTRY CO., LTD., was used, the lithium hydroxide monohydrate powder was weighed and mixed in a proportion of Li/(Ni+Co+Mn)=1.05, and the calcining was carried out with a secondary calcining temperature of 820° C.

### (Evaluation of LiMO2)

In the LiMO2, L_{N} was 0.779 m²/g, and Vl_{0.9}/L_{N} was 3.82. The LiMO2 had a layered structure.

### [Step of Forming Coating Layer]

### (Step of Preparing Coating Liquid)

Under an argon atmosphere (dew point: −30° C. or lower), 28.52 g of pentaethoxy niobium (manufactured by Kojundo Chemical Lab. Co., Ltd.) and 4.75 g of ethoxy lithium (manufactured by Kojundo Chemical Lab. Co., Ltd.) were mixed and dissolved in 385.12 g of dewatered ethanol (manufactured by FUJIFILM Wako Pure Chemical Corporation), and the mixture was stirred for 5 hours. In this manner, a coating liquid 3 was obtained.

### (Coating Step)

A roll-to-roll flow coating device (MP-01, manufactured by Powrex Corp.) was used in the coating step. 600 g of the powder of the LiMO2 was subjected to a pre-treatment of drying at 120° C. for 10 hours in a vacuum atmosphere.

Thereafter, the coating liquid 3 was brought into contact with the surface of the LiMO2 under the following conditions.
Carrier gas: air (nitrogen content: 78%)
Air supply volume: 0.23 m³/min
Air temperature: 200° C.
Spray type: two-fluid nozzle (model: MPXII-LP)
Liquid flow rate of two-fluid nozzle (Qₗ): 3.0 g/min
Air flow rate of two-fluid nozzle (Q_{g}): 64.8 g/min
Rotor rotation speed: 400 rpm
Air pressure of two-fluid nozzle: 0.07 MPa
Q_{g}/Qₗ: 21.6

### (Heating Step)

The coating liquid 3 was brought into contact with the LiMO2, and heat-treated at 300° C. for 5 hours in an air atmosphere to obtain CAM3.

### [Evaluation of CAM3]

The CAM3 contained a coating material that coated at least a part of the surface of the LiMO particles. The coating material had Nb.

In the CAM3, a surface presence rate of the element A was 89.0%, (Va_{0.9}/S_{N})×(Vd_{0.5}−Va_{0.5})/Va_{0.9} was 1.29, and (S_{H}/S_{N})×(Vd_{0.5}−Va_{0.5})/Va_{0.9} was 1.23.

As a result of the composition analysis of the CAM3, in a case of being represented by a compositional formula of Li[Liₓ(Ni_{(1-y-z-w)}Co_{y}Mn_{z}M_{w})₁₋ₓ]O₂, x=0.05, y=0.20, z=0.20, M=Nb, and w=0.02.

An initial charge capacity of the liquid-type lithium secondary battery of the CAM3 was 192 mAh/g, and a second discharge capacity of the all-solid lithium secondary battery was 160 mAh/g. A utilization rate calculated from these values was 83%.

### Example 4

### (Production of CAM4)

### [Step of Producing LiMO]

LiMO3 was obtained by the same method as in Example 3, except that a precursor material having D50 of 6 μm was used, the lithium hydroxide monohydrate powder was weighed and mixed in a proportion of Li/(Ni+Co+Mn)=1.03, and the secondary calcining temperature was changed to 840° C.

### (Evaluation of LiMO3)

In the LiMO3, L_{N} was 0.432 m²/g, and Vl_{0.9}/L_{N} was 5.67. The LiMO3 had a layered structure.

### [Step of Forming Coating Layer]

### (Step of Preparing Coating Liquid)

76.97 g of H₂O₂ water having a concentration of 30% by mass, 87.42 g of pure water, and 5.87 g of niobium oxide hydrate Nb₂O₅·nH₂O (niobium oxide manufactured by Mitsuwa Chemicals Co., Ltd.) were mixed with each other. Next, 11.70 g of ammonia water having a concentration of 28% by mass was added thereto, and the mixture was stirred. Furthermore, 1.71 g of LiOH·H₂O was added thereto to obtain a coating liquid 4 containing a niobium peroxy complex and lithium.

### (Coating Step)

A roll-to-roll flow coating device (MP-01, manufactured by Powrex Corp.) was used in the coating step.

500 g of the powder of the LiMO3 was subjected to a pre-treatment of drying at 120° C. for 10 hours in a vacuum atmosphere.

Thereafter, the coating liquid 4 was brought into contact with the surface of the LiMO3 under the following conditions.
Carrier gas: carbon dioxide-free air (nitrogen content: 78%)
Air supply volume: 0.23 m³/min
Air temperature: 200° C.
Spray type: two-fluid nozzle (model: MPXII-LP)
Liquid flow rate of two-fluid nozzle (Qₗ): 4.5 g/min
Air flow rate of two-fluid nozzle (Q_{g}): 38.7 g/min
Rotor rotation speed: 400 rpm
Air pressure of two-fluid nozzle: 0.07 MPa
Q_{g}/Qₗ: 8.6

### (Heating Step)

The coating liquid 4 was brought into contact with the LiMO3, and heat-treated at 200° C. for 5 hours in an oxygen atmosphere to obtain CAM4.

### [Evaluation of CAM4]

The CAM4 contained a coating material that coated at least a part of the surface of the LiMO particles. The coating material had Nb.

In the CAM4, a surface presence rate of the element A was 78.3%, (Va_{0.9}/S_{N})×(Vd_{0.5}−Va_{0.5})/Va_{0.9} was 2.61, and (S_{H}/S_{N})×(Vd_{0.5}−Va_{0.5})/Va_{0.9} was 1.94.

As a result of the composition analysis of the CAM4, in a case of being represented by a compositional formula of Li[Liₓ(Ni_{(1-y-z-w)}Co_{y}Mn_{z}M_{w})₁₋ₓ]O₂, x=0.05, y=0.20, z=0.20, M=Nb, and w=0.01.

An initial charge capacity of the liquid-type lithium secondary battery of the CAM4 was 197 mAh/g, and a second discharge capacity of the all-solid lithium secondary battery was 168 mAh/g. A utilization rate calculated from these values was 85%.

### Example 5

### (Production of CAM5)

### [Step of Producing LiMO]

LiMO4 was obtained by the same method as in Example 3, except that a cathode precursor material having D50 of 6 μm was used, the lithium hydroxide monohydrate powder was weighed and mixed in a proportion of Li/(Ni+Co+Mn)=1.03, and the obtained crushed product was sieved using a turbo screener, washed with water, and dried.

The washing conditions were as follows.
Solvent: water
Solvent temperature: 5° C.
Slurry concentration: 30% by mass
Stirring time: 10 hours

The dried conditions after the washing with water were such that the product was dried under a reduced pressure at 120° C. for 10 minutes.

### (Evaluation of LiMO4)

In the LiMO4, L_{N} was 0.728 m²/g, and Vl_{0.9}/L_{N} was 0.90. The LiMO4 had a layered structure.

### [Step of Forming Coating Layer]

### (Step of Preparing Coating Liquid)

115.50 g of H₂O₂ water having a concentration of 30% by mass, 131.00 g of pure water, and 8.80 g of niobium oxide hydrate Nb₂O₅·nH₂O (niobium oxide manufactured by Mitsuwa Chemicals Co., Ltd.) were mixed with each other. Next, 17.50 g of ammonia water having a concentration of 28% by mass was added thereto, and the mixture was stirred. Furthermore, 2.51 g of LiOH·H₂O was added thereto to obtain a coating liquid 5 containing a niobium peroxy complex and lithium.

### (Coating Step)

A roll-to-roll flow coating device (MP-01, manufactured by Powrex Corp.) was used in the coating step. 500 g of the powder of the LiMO was subjected to a pre-treatment of drying at 120° C. for 10 hours in a vacuum atmosphere.

Thereafter, the coating liquid 5 was brought into contact with the surface of the LiMO4 under the following conditions.
Carrier gas: carbon dioxide-free dried air (nitrogen content: 78%)
Air supply volume: 0.23 m³/min
Air temperature: 200° C.
Spray type: two-fluid nozzle (model: MPXII-LP)
Liquid flow rate of two-fluid nozzle (Qₗ): 4.5 g/min
Air flow rate of two-fluid nozzle (Q_{g}): 38.7 g/min
Rotor rotation speed: 400 rpm
Air pressure of two-fluid nozzle: 0.07 MPa
Q_{g}/Qₗ: 8.6

### (Heating Step)

The coating liquid 5 was brought into contact with the LiMO4, and heat-treated at 200° C. for 5 hours in an oxygen atmosphere to obtain CAM5.

### [Evaluation of CAM5]

The CAM5 contained a coating material that coated at least a part of the surface of the LiMO particles. The coating material had Nb.

In the CAM5, a surface presence rate of the element A was 78.0%, (Va_{0.9}/S_{N})×(Vd_{0.5}−Va_{0.5})/Va_{0.9} was 0.81, and (S_{H}/S_{N})×(Vd_{0.5}−Va_{0.5})/Va_{0.9} was 1.20.

As a result of the composition analysis of the CAM5, in a case of being represented by a compositional formula of Li[Liₓ(Ni_{(1-y-z-w)}Co_{y}Mn_{z}M_{w})₁₋ₓ]O₂, x=0.02, y=0.19, z=0.19, M=Nb, and w=0.01.

An initial charge capacity of the liquid-type lithium secondary battery of the CAM5 was 194 mAh/g, and a second discharge capacity of the all-solid lithium secondary battery was 146 mAh/g. A utilization rate calculated from these values was 75%.

### Example 6

### (Production of CAM6)

### [Step of Producing LiMO]

LiMO5 was obtained by the same method as in Example 1, except that, as the nickel-cobalt-manganese complex hydroxide 1, a cathode precursor material having Ni/Co/Mn=88.5/9/2.5 and D50 of 3 μm, manufactured by GUANGDONG KINLONG INDUSTRY CO., LTD., was used, the lithium hydroxide monohydrate powder was weighed and mixed in a proportion of Li/(Ni+Co+Mn)=1.05, and the product was washed with water and dried before the crushing step using the mass colloider.

The washing conditions were as follows.
Solvent: water
Solvent temperature: 5° C.
Slurry concentration: 30% by mass
Stirring time: 20 minutes

The dried conditions after the washing with water were at 700° C. for 5 hours in an oxygen atmosphere.

### (Evaluation of LiMO5)

In the LiMO5, L_{N} was 0.520 m²/g, and Vl_{0.9}/L_{N} was 2.41. The LiMO5 had a layered structure.

### [Step of Forming Coating Layer]

### (Step of Preparing Coating Liquid)

194.91 g of H₂O₂ water having a concentration of 30% by mass, 221.12 g of pure water, and 9.88 g of niobium oxide hydrate Nb₂O₅·nH₂O (niobium oxide manufactured by Mitsuwa Chemicals Co., Ltd.) were mixed with each other. Next, 20.03 g of ammonia water having a concentration of 28% by mass was added thereto, and the mixture was stirred. Furthermore, 2.82 g of LiOH·H₂O was added thereto to obtain a coating liquid 6 containing a niobium peroxy complex and lithium.

### (Coating Step)

The coating was carried out in the same manner as in Example 1, except that the coating liquid 6 and the LiMO5 were used.

### (Heating Step)

The coating liquid 6 was brought into contact with the LiMO5, and heat-treated at 200° C. for 5 hours in an oxygen atmosphere to obtain CAM6.

### [Evaluation of CAM6]

The CAM6 contained a coating material that coated at least a part of the surface of the LiMO particles. The coating material had Nb.

In the CAM6, a surface presence rate of the element A was 80.7%, (Va_{0.9}/S_{N})×(Vd_{0.5}−Va_{0.5})/Va_{0.9} was 2.43, and (S_{H}/S_{N})×(Vd_{0.5}−Va_{0.5})/Va_{0.9} was 2.64.

As a result of the composition analysis of the CAM6, in a case of being represented by a compositional formula of Li[Liₓ(Ni_{(1-y-z-w)}Co_{y}Mn_{z}M_{w})₁₋ₓ]O₂, x=0.05, y=0.09, z=0.03, M=Nb, and w=0.01.

An initial charge capacity of the liquid-type lithium secondary battery of the CAM6 was 226 mAh/g, and a second discharge capacity of the all-solid lithium secondary battery was 212 mAh/g. A utilization rate calculated from these values was 94%.

### Example 7

### (Production of CAM7)

### [Step of Producing LiMO]

LiMO3 was obtained by the same method as in Example 4.

### [Step of Forming Coating Layer]

### (Step of Preparing Coating Liquid)

3.89 g of boric acid (H₃BO₃) and 7.78 g of lithium hydroxide monohydrate were added to 462.17 g of pure water, and the mixture was mixed for 2 hours. As a result, a coating liquid 7 containing the boric acid and lithium was obtained.

### (Coating Step)

The coating was carried out in the same manner as in Example 1, except that the coating liquid 7 and the LiMO3 were used.

### (Heating Step)

The coating liquid 7 was brought into contact with the LiMO3, and heat-treated at 300° C. for 5 hours in an oxygen atmosphere to obtain CAM7.

### [Evaluation of CAM7]

The CAM7 contained a coating material that coated at least a part of the surface of the LiMO particles. The coating material had B.

In the CAM7, a surface presence rate of the element A was 81.0%, (Va_{0.9}/S_{N})×(Vd_{0.5}−Va_{0.5})/Va_{0.9} was 2.74, and (S_{H}/S_{N})×(Vd_{0.5}−Va_{0.5})/Va_{0.9} was 1.05.

As a result of the composition analysis of the CAM7, in a case of being represented by a compositional formula of Li[Liₓ(Ni_{(1-y-z-w)}Co_{y}Mn_{z}M_{w})₁₋ₓ]O₂, x=0.10, y=0.20, z=0.20, M=B, and w=0.01.

An initial charge capacity of the liquid-type lithium secondary battery of the CAM7 was 195 mAh/g, and a second discharge capacity of the all-solid lithium secondary battery was 150 mAh/g. A utilization rate calculated from these values was 77%.

### Example 8

### (Production of CAM8)

### [Step of Producing LiMO]

LiMO3 was obtained by the same method as in Example 4.

### [Step of Forming Coating Layer]

### (Step of Preparing Coating Liquid)

8.21 g of hydrogen diammonium phosphate (manufactured by FUJIFILM Wako Pure Chemical Corporation) was added to 337.78 g of pure water, and the mixture was stirred for 2 hours. As a result, a coating liquid 8 containing phosphorus was obtained.

### (Coating Step)

The coating was carried out in the same manner as in Example 1, except that the coating liquid 8 and the LiMO3 were used.

### (Heating Step)

The coating liquid 8 was brought into contact with the LiMO3, and heat-treated at 300° C. for 5 hours in an oxygen atmosphere to obtain CAM8.

### [Evaluation of CAM8]

The CAM8 contained a coating material that coated at least a part of the surface of the LiMO particles. The coating material had P.

In the CAM8, a surface presence rate of the element A was 70%, (Va_{0.9}/S_{N})×(Vd_{0.5}−Va_{0.5})/Va_{0.9} was 0.55, and (S_{H}/S_{N})×(Vd_{0.5}−Va_{0.5})/Va_{0.9} was 0.59.

As a result of the composition analysis of the CAM8, in a case of being represented by a compositional formula of Li[Liₓ(Ni_{(1-y-z-w)}Co_{y}Mn_{z}M_{w})₁₋ₓ]O₂, x=0.05, y=0.21, z=0.20, M=P, and w=0.01.

An initial charge capacity of the liquid-type lithium secondary battery of the CAM8 was 197 mAh/g, and a second discharge capacity of the all-solid lithium secondary battery was 141 mAh/g. A utilization rate calculated from these values was 72%.

### Comparative Example 1

### (Production of CAM9)

### [Step of Producing LiMO]

LiMO6 was obtained by the same method as in Example 6, except that the washing with water and the subsequent drying were not carried out.

### (Evaluation of LiMO6)

In the LiMO6, L_{N} was 0.753 m²/g, and Vl_{0.9}/L_{N} was 6.82. The LiMO6 had a layered structure.

### [Step of Forming Coating Layer]

### (Step of Preparing Coating Liquid)

316.90 g of H₂O₂ water having a concentration of 30% by mass, 359.76 g of pure water, and 16.09 g of niobium oxide hydrate Nb₂O₅·nH₂O (niobium oxide manufactured by Mitsuwa Chemicals Co., Ltd.) were mixed with each other. Next, 31.99 g of ammonia water having a concentration of 28% by mass was added thereto, and the mixture was stirred. Furthermore, 4.62 g of LiOH·H₂O was added thereto to obtain a coating liquid 9 containing a niobium peroxy complex and lithium.

### (Coating Step)

The coating was carried out in the same manner as in Example 1, except that the coating liquid 9 and the LiMO6 were used.

### (Heating Step)

The coating liquid 9 was brought into contact with the LiMO6, and heat-treated at 200° C. for 5 hours in an oxygen atmosphere to obtain CAM9.

### [Evaluation of CAM9]

The CAM9 contained a coating material that coated at least a part of the surface of the LiMO particles. The coating material had Nb.

In the CAM9, a surface presence rate of the element A was 88.3%, (Va_{0.9}/S_{N})×(Vd_{0.5}−Va_{0.5})/Va_{0.9} was 2.84, and (S_{H}/S_{N})×(Vd_{0.5}−Va_{0.5})/Va_{0.9} was 3.11.

As a result of the composition analysis of the CAM9, in a case of being represented by a compositional formula of Li[Liₓ(Ni_{(1-y-z-w)}Co_{y}Mn_{z}M_{w})₁₋ₓ]O₂, x=0.08, y=0.09, z=0.02, M=Nb, and w=0.02.

An initial charge capacity of the liquid-type lithium secondary battery of the CAM9 was 215 mAh/g, and a second discharge capacity of the all-solid lithium secondary battery was 109 mAh/g. A utilization rate calculated from these values was 51%.

### Comparative Example 2

### (Production of CAM10)

### [Step of Producing LiMO]

LiMO1 was obtained by the same method as in Example 1.

### [Step of Forming Coating Layer]

### (Step of Preparing Coating Liquid)

177.42 g of H₂O₂ water having a concentration of 30% by mass, 201.33 g of pure water, and 9.07 g of niobium oxide hydrate Nb₂O₅·nH₂O (niobium oxide manufactured by Mitsuwa Chemicals Co., Ltd.) were mixed with each other. Next, 17.98 g of ammonia water having a concentration of 28% by mass was added thereto, and the mixture was stirred. Furthermore, 2.59 g of LiOH·H₂O was added thereto to obtain a coating liquid 10 containing a niobium peroxy complex and lithium.

### (Coating Step)

A roll-to-roll flow coating device (MP-01, manufactured by Powrex Corp.) was used in the coating step.

500 g of the powder of the LiMO was subjected to a pre-treatment of drying at 120° C. for 10 hours in a vacuum atmosphere.

Thereafter, the coating liquid 10 was brought into contact with the surface of the LiMO1 under the following conditions.
Carrier gas: carbon dioxide-free dried air (nitrogen content: 78%)
Air supply volume: 0.23 m³/min
Air temperature: 200° C.
Spray type: two-fluid nozzle (model: MPXII-LP)
Liquid flow rate of two-fluid nozzle (Qₗ): 1.5 g/min
Air flow rate of two-fluid nozzle (Q_{g}): 38.7 NL/min
Rotor rotation speed: 400 rpm
Air pressure of two-fluid nozzle: 0.07 MPa
Q_{g}/Qₗ: 25.9

### (Heating Step)

The coating liquid 10 was brought into contact with the LiMO1, and heat-treated at 200° C. for 5 hours in an oxygen atmosphere to obtain CAM10.

### [Evaluation of CAM10]

The CAM10 contained a coating material that coated at least a part of the surface of the LiMO particles. The coating material had Nb.

In the CAM10, a surface presence rate of the element A was 68.5%, (Va_{0.9}/S_{N})×(Vd_{0.5}−Va_{0.5})/Va_{0.9} was 0.91, and (S_{H}/S_{N})×(Vd_{0.5}−Va_{0.5})/Va_{0.9} was 1.63.

As a result of the composition analysis of the CAM10, in a case of being represented by a compositional formula of Li[Liₓ(Ni_{(1-y-z-w)}Co_{y}Mn_{z}M_{w})₁₋ₓ]O₂, x=0.10, y=0.20, z=0.22, M=Nb, and w=0.01.

An initial charge capacity of the liquid-type lithium secondary battery of the CAM10 was 191 mAh/g, and a second discharge capacity of the all-solid lithium secondary battery was 98 mAh/g. A utilization rate calculated from these values was 51%.

### Comparative Example 3

### (Production of CAM11)

### [Step of Producing LiMO]

LiMO3 was obtained by the same method as in Example 4.

### (Step of Preparing Coating Liquid)

77.80 g of boric acid (H₃BO₃) and 155.60 g of lithium hydroxide monohydrate were added to 9243.40 g of pure water, and the mixture was mixed for 2 hours. As a result, a coating liquid 11 containing the boric acid and lithium was obtained.

### (Coating Step)

In the coating step, a rigid mixer (manufactured by NIPPON COKE & ENGINEERING CO., LTD., FM20C/L) was used.

The coating liquid 11 was brought into contact with the surface of 10 kg LiMO3.
Introduction air: air
Air supply volume: no air
Air temperature: jacket oil temperature of 150° C.
Spray type: two-fluid nozzle (manufactured by ATOMEX, AM25S-ISVL)
Liquid flow rate of two-fluid nozzle: 26 g/min
Air pressure of two-fluid nozzle: 0.1 MPa
Air flow rate of two-fluid nozzle: 15.6 g/min
Mixer rotation speed: 1,050 rpm
Q_{g}/Qₗ: 0.6

### (Heating Step)

The coating liquid 11 was brought into contact with the LiMO3, and heat-treated at 300° C. for 5 hours in an oxygen atmosphere to obtain CAM11.

### [Evaluation of CAM11]

The CAM11 contained a coating material that coated at least a part of the surface of the LiMO particles. The coating material had B.

In the CAM11, a surface presence rate of the element A was 54.2%, (Va_{0.9}/S_{N})×(Vd_{0.5}−Va_{0.5})/Va_{0.9} was 12.40, and (S_{H}/S_{N})×(Vd_{0.5}−Va_{0.5})/Va_{0.9} was 1.31.

As a result of the composition analysis of the CAM11, in a case of being represented by a compositional formula of Li[Liₓ(Ni_{(1-y-z-w)}Co_{y}Mn_{z}M_{w})₁₋ₓ]O₂, x=0.07, y=0.20, z=0.20, M=B, and w=0.01.

An initial charge capacity of the liquid-type lithium secondary battery of the CAM11 was 199 mAh/g, and a second discharge capacity of the all-solid lithium secondary battery was 118 mAh/g. A utilization rate calculated from these values was 59%.

The results of the physical properties and the utilization rate of the CAM of Examples 1 to 8 and Comparative Examples 1 to 3 are shown in Table 4. In Table 4, (2) is (Va_{0.9}/S_{N})×(Vd_{0.5}−Va_{0.5})/Va_{0.9}, (3) is (S_{H}/S_{N})×(Vd_{0.5}−Va_{0.5})/Va_{0.9}, (A) is Vl_{0.9}/L_{N}, and (B) is Q_{g}/Qₗ.

TABLE 4

| | Surface | | | | | |
|---|---|---|---|---|---|---|
| | presence rate | | | | | |
| | of element | | | | | Utilization |
| | A % | (2) | (3) | (A) | (B) | rate (%) |
| Example 1 | 86.6 | 2.64 | 1.93 | 2.58 | 14.4 | 80 |
| Example 2 | 70.5 | 1.42 | 1.27 | 2.58 | 14.4 | 90 |
| Example 3 | 89.0 | 1.29 | 1.23 | 3.82 | 21.6 | 83 |
| Example 4 | 78.3 | 2.61 | 1.94 | 5.67 | 8.6 | 85 |
| Example 5 | 78.0 | 0.81 | 1.20 | 0.90 | 8.6 | 75 |
| Example 6 | 80.7 | 2.43 | 2.64 | 2.41 | 14.4 | 94 |
| Example 7 | 81.0 | 2.74 | 1.05 | 5.67 | 14.4 | 77 |
| Example 8 | 70.0 | 0.55 | 0.59 | 5.67 | 14.4 | 72 |
| Comparative | 88.3 | 2.84 | 3.11 | 6.82 | 14.4 | 51 |
| Example 1 | | | | | | |
| Comparative | 68.5 | 0.91 | 1.63 | 2.58 | 25.9 | 51 |
| Example 2 | | | | | | |
| Comparative | 54.2 | 12.4 | 1.31 | 5.67 | 0.6 | 59 |
| Example 3 | | | | | | |

In Comparative Example 1 in which Vl_{0.9}/L_{N} was 6.82 and the LiMO having a high hydrophilicity of the surface was used, it is considered that, in the coating step, the excessive adhesion of liquid droplets caused an increase in the resistance layer due to the increase in the amount of residual moisture, and thus the utilization rate was reduced.

In Comparative Example 2 in which Q_{g}/Qₗ was 25.9, it is considered that the surface presence rate of the element A was low because the liquid droplets of the coating liquid were too small, and thus the appropriate amount of the coating raw material could not adhere to the LiMO or evaporated before the adhering.

In Comparative Example 3 in which Q_{g}/Qₗ was 0.6, it is considered that the surface presence rate of the element A was low because the dispersion state of the coating liquid was deteriorated, and the amount of the coating raw material which could not adhere to the LiMO was increased. In addition, it is considered that very large droplets collided with the LiMO, dried and aggregated on the surface of the LiMO, and turned into CAM that exhibited excessive hydrophilicity.

### REFERENCE SIGNS LIST

100: Laminate
110: Cathode
111: Cathode active material layer
112: Cathode current collector
113: External terminal
120: Anode
121: Anode active material layer
122: Anode current collector
123: External terminal
130: Solid electrolyte layer
200: Exterior body
200a: Opening portion
1000: Solid lithium secondary battery

1. A cathode active material for solid lithium secondary battery, comprising:
a lithium metal composite oxide having a layered crystal structure; and
a coating material which coats at least a part of the lithium metal composite oxide,
wherein the coating material contains an element A,
the element A is one or more elements selected from the group consisting of Nb, Ta, Ti, Al, B, P, W, Zr, La, and Ge, and
the following (1) and (2) are satisfied,
(1) a surface presence rate of the coating material is 70% or more, and
(2) 0.10<(Va_{0.9}/S_{N})×(Vd_{0.5}−Va_{0.5})/Va_{0.9}<2.80,
[S_{N} is a BET specific surface area (unit: m²/g) of the cathode active material for solid lithium secondary battery, which is obtained by a measurement using a nitrogen adsorption method,
Va_{0.5} is a water vapor adsorption amount (unit: cm³ (STP)/g) of the cathode active material for solid lithium secondary battery in a case where, in an adsorption isotherm obtained by a measurement using a water vapor adsorption method, a relative pressure p/pₒ with a saturated vapor pressure p₀ is 0.5,
Va_{0.9} is a water vapor adsorption amount (unit: cm³ (STP)/g) of the cathode active material for solid lithium secondary battery in a case where, in the adsorption isotherm obtained by the measurement using the water vapor adsorption method, the relative pressure p/pₒ is 0.9, and
Vd_{0.5} is a water vapor adsorption amount (unit: cm³ (STP)/g) of the cathode active material for solid lithium secondary battery in a case where, in a desorption isotherm obtained by a measurement using a water vapor adsorption method, the relative pressure p/pₒ is 0.5].

2. The cathode active material for solid lithium secondary battery according to claim 1,
wherein S_{H}, S_{N}, Va_{0.5}, Va_{0.9}, and Vd_{0.5} satisfy the following (3),
$$0.1 < ( {S}_{H} / {S}_{N} ) \times ( {Vd}_{0.5} - {Va}_{0.5} ) / {Va}_{0.9} < 3.1 , \qquad ( 3 )$$
[S_{H} is a BET specific surface area (unit: m²/g) of the cathode active material for solid lithium secondary battery, which is obtained by a measurement using a water vapor adsorption method].

3. The cathode active material for solid lithium secondary battery according to claim 1,
wherein the cathode active material is used by being brought into contact with a solid electrolyte.

4. The cathode active material for solid lithium secondary battery according to claim 3,
wherein the solid electrolyte is a sulfide-based solid electrolyte.

5. The cathode active material for solid lithium secondary battery according to claim 1,
wherein the element A is Nb, P, or B.

6. The cathode active material for solid lithium secondary battery according to claim 1,
wherein the following formula (I) is satisfied,
(Li[Liₓ(Ni_{(1-y-z-w)}Co_{y}Mn_{z}M_{w})₁₋ₓ]O₂ (I)
(here, M is at least one element selected from the group consisting of Fe, Cu, Mg, Al, W, B, P, Mo, Zn, Sn, Zr, Ga, La, Ti, Nb, Ta, Ge, and V, and −0.10≤x≤0.30, 0≤y≤0.40, 0≤z≤0.40, and 0<w≤0.10 are satisfied).

7. A method for manufacturing a cathode active material for solid lithium secondary battery, the method comprising:
a coating step of coating at least a part of a surface of a lithium metal composite oxide using a coating device,
wherein the coating device used in the coating step includes a treatment section in which the lithium metal composite oxide is flowable, and further includes a two-fluid nozzle which jets, toward the lithium metal composite oxide, a two-fluid jet containing a liquid coating raw material containing an element A and a carrier gas,
the element A is one or more elements selected from the group consisting of Nb, Ta, Ti, Al, B, P, W, Zr, La, and Ge,
the lithium metal composite oxide satisfies the following (A), and
Q_{g}, which is a flow rate (unit: g/min) of the carrier gas, and Qₗ, which is a flow rate (unit: g/min) of the coating raw material, satisfy the following (B),
$$0.1 < {Vl}_{0.9} / {L}_{N} < 6.8 , \qquad ( A )$$
(L_{N} is a BET specific surface area (unit: m²/g) of the lithium metal composite oxide, which is measured by a nitrogen adsorption method, and
Vl_{0.9} is a water vapor adsorption amount (unit: cm³ (STP)/g) of the lithium metal composite oxide in a case where, in an adsorption isotherm of a water vapor adsorption method, a relative pressure p/pₒ with a saturated vapor pressure p₀ is 0.9), and
$$0.6 < {Q}_{g} / {Q}_{l} \leq 25. . \qquad ( B )$$

8. The method for manufacturing a cathode active material for solid lithium secondary battery according to claim 7, further comprising, after the coating step:
a heating step.

9. The method for manufacturing a cathode active material for solid lithium secondary battery according to claim 8,
wherein the heating step is a step of performing heating at a temperature of 100° C. or higher and 500° C. or lower for 1 hour or longer.

10. The method for manufacturing a cathode active material for solid lithium secondary battery according to claim 7,
wherein the carrier gas is a gas having nitrogen as a main component.

11. The method for manufacturing a cathode active material for solid lithium secondary battery according to claim 7,
wherein the cathode active material for solid lithium secondary battery satisfies the following formula (I),
(Li[Liₓ(Ni_{(1-y-z-w)}Co_{y}Mn_{z}M_{w})₁₋ₓ]O₂ (I)
(here, M is at least one element selected from the group consisting of Fe, Cu, Mg, Al, W, B, P, Mo, Zn, Sn, Zr, Ga, La, Ti, Nb, Ta, Ge, and V, and −0.10≤x≤0.30, 0≤y≤0.40, 0≤z≤0.40, and 0<w≤0.10 are satisfied).

12. The method for manufacturing a cathode active material for solid lithium secondary battery according to claim 7,
wherein the coating step is a step of performing the coating using a roll-to-roll flow coating device.

13. The cathode active material for solid lithium secondary battery according to claim 2,
wherein the cathode active material is used by being brought into contact with a solid electrolyte.

14. The cathode active material for solid lithium secondary battery according to claim 2,
wherein the element A is Nb, P, or B.

15. The cathode active material for solid lithium secondary battery according to claim 2,
wherein the following formula (I) is satisfied,
(Li[Liₓ(Ni_{(1-y-z-w)}Co_{y}Mn_{z}M_{w})₁₋ₓ]O₂ (I)
(here, M is at least one element selected from the group consisting of Fe, Cu, Mg, Al, W, B, P, Mo, Zn, Sn, Zr, Ga, La, Ti, Nb, Ta, Ge, and V, and −0.10≤x≤0.30, 0≤y≤0.40, 0≤z≤0.40, and 0<w≤0.10 are satisfied).

16. The method for manufacturing a cathode active material for solid lithium secondary battery according to claim 8,
wherein the carrier gas is a gas having nitrogen as a main component.

17. The method for manufacturing a cathode active material for solid lithium secondary battery according to claim 8,
wherein the cathode active material for solid lithium secondary battery satisfies the following formula (I),
(Li[Liₓ(Ni_{(1-y-z-w)}Co_{y}Mn_{z}M_{w})₁₋ₓ]O₂ (I)
(here, M is at least one element selected from the group consisting of Fe, Cu, Mg, Al, W, B, P, Mo, Zn, Sn, Zr, Ga, La, Ti, Nb, Ta, Ge, and V, and −0.10≤x≤0.30, 0≤y≤0.40, 0≤z≤0.40, and 0<w≤0.10 are satisfied).

18. The method for manufacturing a cathode active material for solid lithium secondary battery according to claim 8,
wherein the coating step is a step of performing the coating using a roll-to-roll flow coating device.
